(19) United States
(12) Patent Application Publication
(10) Pub. No.: US 2009/0144226 A1
(43) Pub. Date: Jun. 4, 2009

(54) INFORMATION PROCESSING DEVICE AND METHOD, AND PROGRAM

(76) Inventor: Kei TATENO, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/325,406

(22) Filed: Dec. 1, 2008

(30) Foreign Application Priority Data
Dec. 3, 2007 (JP) P2007-312722
Jul. 2, 2008 (JP) P2008-173489

(51) Int. Cl. G06F 17/30

(52) U.S. Cl. 707/1; 707/E17.046

(57) ABSTRACT

An information processing device includes an item evaluation acquiring section configured to acquire evaluation values given to individual items by individual users, a user statistics calculating section configured to calculate user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user, and a presentation control section configured to control presentation of information related to an item to the noted user, on the basis of the user statistics.

### CROSS REFERENCES TO RELATED APPLICATIONS

The present invention contains subject matter related to Japanese Patent Applications JP 2007-312722 and JP 2008-173489 respectively filed in the Japanese Patent Office on Dec. 3, 2007 and Jul. 2, 2008, the entire contents of which are incorporated herein by reference.

### BACKGROUND OF THE INVENTION

1. Field of the Invention

The present invention relates to an information processing device and method, and a program. More specifically, the present invention relates to an information processing device and method, and a program which enable more effective use of users' evaluations given to items.

2. Description of the Related Art

In the related art, there have been proposed various inventions for so-called content personalization, in which various items such as television programs, pieces of music, and products are retrieved and recommended on the basis of the preferences of a user (see, for example, Japanese Unexamined Patent Application Publication No. 2004-194107 or P. Resnick, N. Iacovou, M. Suchak, P. Bergstrom, and J. RIedl. “GroupLens: Open Architecture for Collaborative FilterIng of Netnews.” Conference on Computer Supported Cooperative Work, pp. 175-186, 1994). For content personalization, methods such as cooperative filtering (CF) based on users' evaluations, and content-based filtering (CBF) based on the contents of information are widely used.

### SUMMARY OF THE INVENTION

For cases when items are recommended on the basis of users' evaluations by cooperative filtering or the like in the related art, in order to allow recommendation of more appropriate items, it is desired to enable more effective use of users' evaluations given to items.

It is thus desirable to make it possible to use users' evaluations given to items more effectively.

An information processing device according to an embodiment of the present invention includes: item evaluation acquiring means for acquiring evaluation values given to individual items by individual users; user statistics calculating means for calculating user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user; and presentation control means for controlling presentation of information related to an item to the noted user, on the basis of the user statistics.

The information processing device may further include item clustering means for clustering items by using a predetermined method, and the user statistics calculating means may calculate the user statistics on the basis of a cluster-specific distribution of the numbers of items evaluated by the noted user.

The user statistics may include a community representativeness index indicating a similarity index between the cluster-specific distribution of the numbers of items evaluated by the noted user, and the cluster-specific distribution of the numbers of evaluations by an entire community to which the noted user belongs.

The user statistics may further include a trendiness index based on a time-series average of the community representativeness index.

The user statistics may include a consistency index indicating a time-series stability index of the cluster-specific distribution of the numbers of items evaluated by the noted user.

The user statistics may include a bias index indicating a degree of bias in the cluster-specific distribution of the numbers of items evaluated by the noted user.

The presentation control means may control the presentation so as to select and present information matching a characteristic of the noted user represented by the user statistics.

The information processing device may further include item statistics calculating means for calculating item statistics representing a tendency of evaluations given to individual items, on the basis of at least one of evaluation values and the numbers of evaluations given by individual users.

The user statistics calculating means may calculate the user statistics of the noted user on the basis of a characteristic possessed by a large number of items evaluated by the noted user, among item characteristics represented by the item statistics.

The item statistics may include at least one of an instantaneousness index based on a relative value of speed of decrease of the number of evaluations on each individual item with respect to an average speed of decrease of the number of evaluations from when individual items become available, a word-of-mouth index indicating a length of period during which the number of evaluations on each individual item increases and a degree of increase in the number of evaluations, and a standardness index indicating a time-series stability index of the number of evaluations on each individual item, and the user statistics may include at least one of a fad chaser index based on a ratio of items evaluated within a predetermined period after the items become available and each having the instantaneousness index equal to or higher than a predetermined threshold, to items evaluated by the noted user, a connoisseur index based on a ratio of items evaluated within a predetermined period after the items become available and each having the word-of-mouth index equal to or higher than a predetermined threshold, to items evaluated by the noted user, and a conservativeness index based on a ratio of items each having the standardness index equal to or higher than a predetermined threshold, to items evaluated by the noted user.

The item statistics may include an item regular-fan index based on an average number of evaluations per one user on each individual item within a predetermined period, and the user statistics may include a user regular-fan index based on a ratio of items each having the item regular-fan index equal to or higher than a predetermined threshold, to items evaluated by the noted user.

The item statistics may include a majorness index based on the number of evaluations on each individual item, and an evaluation average that is an average of evaluation values of each individual item, and the user statistics may include a fad chaser index based on an average of the majorness index of each individual item evaluated by the noted user, a majorness orientation index based on a correlation between an evaluation value given to each individual item by the noted user and the majorness index of the item, an ordinariness index based on a correlation between an evaluation value given to each individual item by the noted user and the evaluation average of the item, and a reputation orientation index based on an average of the evaluation average of each individual item evaluated by the noted user.

The presentation control means may highlight and present an item characteristic represented by the item statistics and associated with a characteristic of the noted user represented by the user statistics.

The information processing device may further include extracting means for extracting an item having a characteristic represented by the item statistics and associated with a characteristic of the noted user represented by the user statistics, and the presentation control means may control the presentation so as to present the extracted item to the noted user.

The information processing device may further include: user similarity index calculating means for calculating a user similarity index indicating a similarity index between users, on the basis of the user statistics; similar user extracting means for extracting a similar user similar to the noted user; and extracting means for extracting an item to which a high evaluation value is given by the similar user, as an item to be recommended to a noted user, and the presentation control means may control the presentation so as to present the extracted item as an item to be recommended to the noted user.

The information processing device may further include: user similarity index calculating means for calculating a user similarity index indicating a similarity index between users, on the basis of the user statistics; predicted evaluation value calculating means for calculating a predicted value of an evaluation value given to a noted item by the noted user, by using evaluation values given to the noted item by other users, and by assigning a large weight to an evaluation value given by a user whose value of the user similarity index to the noted user is high, and assigning a small weight to an evaluation value given by a user whose value of the user similarity index to the noted user is low; and extracting means for extracting an item for which the predicted evaluation value is high, as an item to be recommended to the noted user, and the presentation control means may control the presentation so as to present the extracted item as an item to be recommended to the noted user.

An information processing method according to an embodiment of the present invention includes the steps of: acquiring evaluation values given to individual items by individual users; calculating user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user; and controlling presentation of information related to an item to the noted user, on the basis of the user statistics.

A program according to an embodiment of the present invention causes a computer to execute a process including the steps of: acquiring evaluation values given to individual items by individual users; calculating user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user; and controlling presentation of information related to an item to the noted user, on the basis of the user statistics.

According to an embodiment of the present invention, evaluation values given to individual items by individual users are acquired, user statistics indicating an evaluation tendency of a noted user are calculated by using at least one of the number of items evaluated by the noted user, evaluation values given by the noted user to individual items, the numbers of evaluations given by individual users to items evaluated by the noted user, and evaluation values given by individual users to items evaluated by the noted user, and presentation of information related to an item to the noted user is controlled on the basis of the user statistics.

According to an embodiment of the present invention, evaluations given to items by users can be used more effectively. In particular, according to an embodiment of the present invention, information related to an item can be appropriately presented to a user.

### BRIEF DESCRIPTION OF THE DRAWINGS

FIG. 1 is a block diagram showing an information processing system according to an embodiment of the present invention;

FIG. 2 is a flowchart illustrating an item evaluation acquiring process;

FIG. 3 is a diagram showing an example of item evaluation history;

FIG. 4 is a flowchart illustrating an item characteristic calculating process;

FIG. 5 is a diagram showing an example of item statistics;

FIG. 6 is a diagram showing an example of ranks in item statistics;

FIG. 7 is a diagram showing an example of item type indexes;

FIG. 8 is a flowchart illustrating a similar item extracting process;

FIG. 9 is a diagram showing an example of item similarity indexes;

FIG. 10 is a flowchart illustrating a user characteristic calculating process;

FIG. 11 is a diagram showing an example of user statistics;

FIG. 12 is a diagram showing an example of relative fad chaser indexes;

FIG. 13 is a flowchart illustrating a similar user extracting process;

FIG. 14 is a diagram showing an example of inter-user distances and user similarity indexes;

FIG. 15 is a flowchart illustrating an item recommending process;

FIG. 16 is a flowchart illustrating a second embodiment of an item recommending process;

FIG. 17 is a table summarizing formulae for calculating individual indexes for determining item types;

FIG. 18 is a table summarizing the relationship between the evaluation average, evaluation variance, and number of evaluations of an item, and each item type;

FIG. 19 is a block diagram showing an information processing system according to a second embodiment of the present invention;

FIG. 20 is a flowchart illustrating a user characteristic (reputation orientation index) calculating process;

FIG. 21 is a flowchart illustrating a user characteristic (majority orientation index) calculating process;

FIG. 22 is a diagram showing an example of classification of users into user clusters;

FIG. 23 is a flowchart illustrating a user characteristic (bias index) calculating process;

FIG. 24 is a diagram showing an example of classification of items into item clusters;

FIG. 25 is a diagram showing an example of the result of tabulating the number of items evaluated by a user by item cluster;

FIG. 26 is a diagram showing another example of the result of tabulating the number of items evaluated by a user by item cluster;

FIG. 27 is a flowchart illustrating a user characteristic (community representativeness index) calculating process;

FIG. 28 is a diagram showing an example of the result of tabulating the total number of evaluations by all users by item cluster;

FIG. 29 is a flowchart illustrating a user characteristic (consistency index/trendiness index/my-own-current-obsession index) calculating process;

FIG. 30 is a diagram showing an example of time transition of the distribution of the numbers of evaluations by a user by item cluster;

FIG. 31 is a diagram showing another example of time transition of the distribution of the numbers of evaluations by a user broken down by item cluster;

FIG. 32 is a diagram showing a still another example of time transition of the distribution of the numbers of evaluations by a user broken down by item cluster;

FIG. 33 is a diagram showing an example of time transition of the distribution of the total numbers of evaluations by all users broken down by item cluster;

FIG. 34 is a flowchart illustrating an item characteristic (instantaneousness index/word-of-mouth index/standardness index/regular-fan index) calculating process;

FIG. 35 is a diagram showing an example of the result of tabulating the numbers of evaluations on items for each relative period;

FIG. 36 is a diagram showing the result of calculating the numbers of evaluations relative to previous period, with respect to the tabulated result of items in FIG. 35;

FIG. 37 is a diagram showing an example of time transition of the number of evaluations on an instantaneous type item;

FIG. 38 is a diagram showing an example of time transition of the number of evaluations on a word-of-mouth type item;

FIG. 39 is a diagram showing an example of time transition of the number of evaluations on a standard type item;

FIG. 40 is a diagram showing an example of time transition of the number of evaluations on an item by each individual user;

FIG. 41 is a diagram showing another example of time transition of the number of evaluations on an item by each individual user;

FIG. 42 is a flowchart illustrating a user characteristic (fad chaser B index/connoisseur index/conservativeness index/regular-fan index) calculating process;

FIG. 43 is a table summarizing item characteristics;

FIG. 44 is a table summarizing user characteristics;

FIG. 45 is a flowchart illustrating an information block personalization process;

FIG. 46 is a diagram showing an example of a screen that is displayed to a user through an information block personalization process, in a music distribution service;

FIG. 47 is a diagram showing another example of a screen that is displayed to a user through an information block personalization process, in a music distribution service;

FIG. 48 is a flowchart illustrating a filtering process;

FIG. 49 is a diagram illustrating a specific example of filtering process;

FIG. 50 is a flowchart illustrating an item characteristic highlighting process;

FIG. 51 is a diagram showing an example of a screen that is displayed to a user through an item characteristic highlighting process, in a music distribution service;

FIG. 52 is a flowchart illustrating a hit prediction process;

FIG. 53 is a diagram showing an example of possession rates of user characteristics;

FIG. 54 is a diagram showing another example of possession rates of user characteristics; and

FIG. 55 is a diagram showing an example of the configuration of a computer.

### DESCRIPTION OF THE PREFERRED EMBODIMENTS

Hereinbelow, an embodiment of the present invention will be described with reference to the drawings.

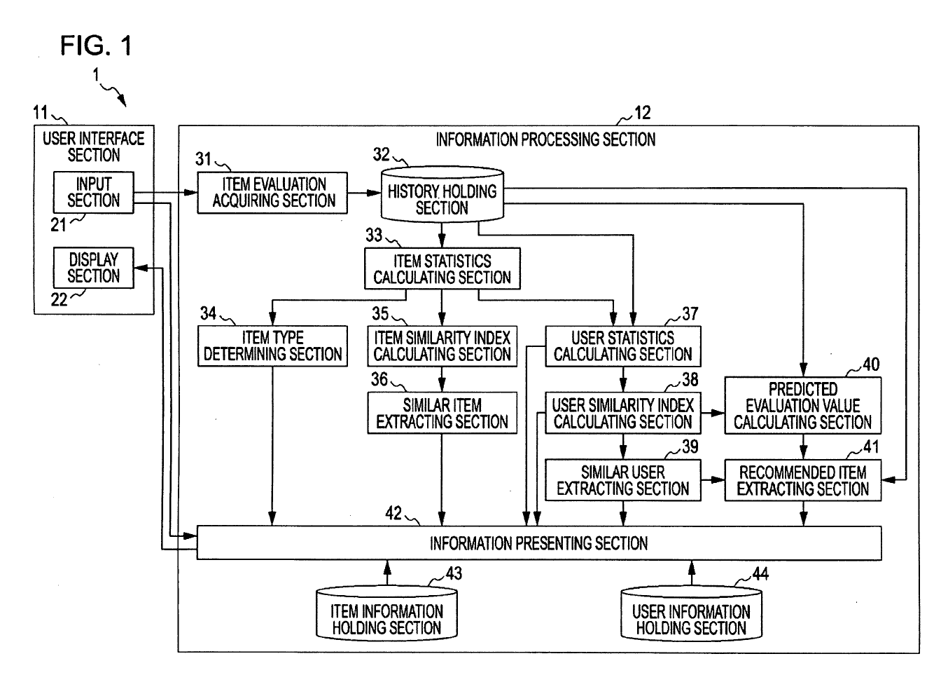

FIG. 1 is a block diagram showing an information processing system according to an embodiment of the present invention. An information processing system 1 in FIG. 1 is a system that provides items, information related to items, information related to users of the information processing system 1, and the like to a user. The term items as used herein refer to various kinds of content such as television programs, moving images, still images, documents, pieces of music, software, and information, various products, and the like. The information processing system 1 includes a user interface section 11 and an information processing section 12.

The user interface section 11 is used when a user inputs information or a command to the information processing section 12, or when presenting items or information provided from the information processing section 12 to a user. The user interface section 11 includes an input section 21 configured by a keyboard, a mouse, or the like, and a display section 22 configured by a display or the like included in CE (Consumer Electronics) equipment.

The information processing section 12 includes an item evaluation acquiring section 31, a history holding section 32, an item statistics calculating section 33, an item type determining section 34, an item similarity index calculating section 35, a similar item extracting section 35, a user statistics calculating section 37, a user similarity index calculating section 38, a similar user extracting section 39, a predicted evaluation value calculating section 40, a recommended item extracting section 41, an information presenting section 42, an item information holding section 43, and a user information holding section 44.

The item evaluation acquiring section 31 performs acquisition of information indicating evaluations on individual items inputted by individual users via the input section 21, and recording of the acquired information to an item evaluation history held in the history holding section 32.

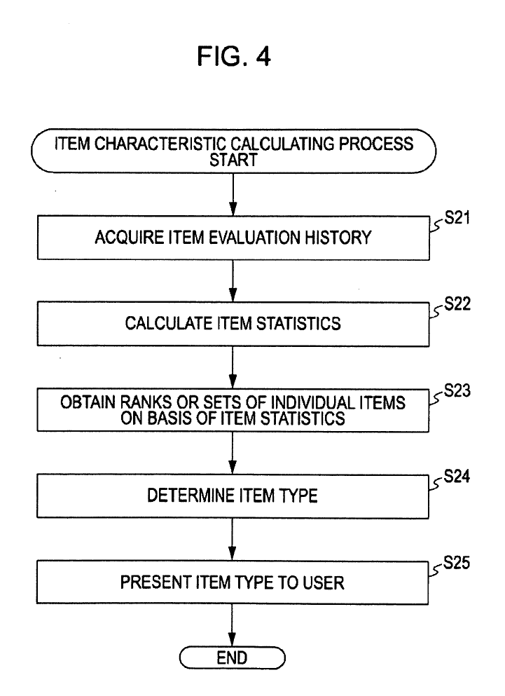

As will be described later with reference to FIG. 4 and the like, the item statistics calculating section 33 calculates item statistics indicating the tendency of evaluations on individual items, on the basis of item history information held by the history holding section 32. The item statistics calculating section 33 supplies information indicating the calculated item statistics to the item type determining section 34, the item similarity index calculating section 35, and the user statistics calculating section 37, as necessary.

As will be described later with reference to FIG. 4 and the like, the item type determining section 34 determines an item type indicating a characteristic of each individual item based on the tendency of evaluations given to that item. The item type determining section 34 supplies information indicating the item types of individual items to the information presenting section 42.

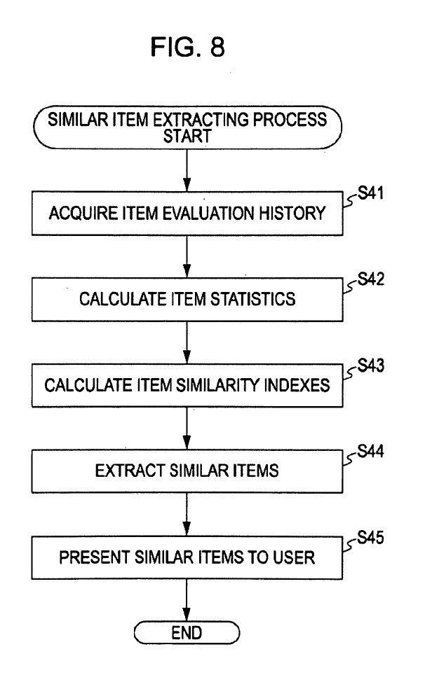

As will be described later with reference to FIG. 8 and the like, the item similarity index calculating section 35 calculates item similarity indexes indicating similarity indexes in evaluation tendency among items. The item similarity index calculating section 35 supplies information indicating the calculated item similarity indexes to the similar item extraction section 36.

As will be described later with reference to FIG. 8 and the like, the similar item extracting section 36 extracts, with respect to individual items, similar items that are similar to the items, on the basis of the item similarity indexes. The similar item extracting section 36 supplies information indicating similar items for individual items to the information presenting section 42.

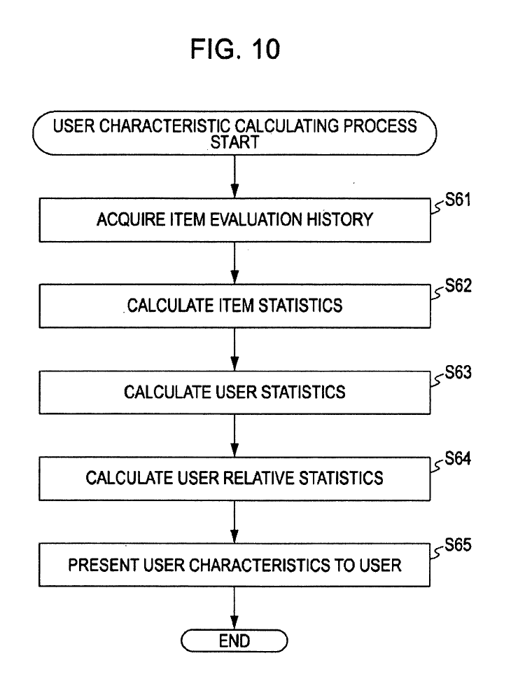

As will be described later with reference to FIG. 10 and the like, the user statistics calculating section 37 calculates user statistics indicating the characteristics of individual users based on the tendencies of evaluations given to individual items, on the basis of an item evaluation history and item statistics. The user statistics calculating section 37 supplies information indicating the calculated user statistics to the user similarity index calculating section 38 and the information presenting section 42, as necessary.

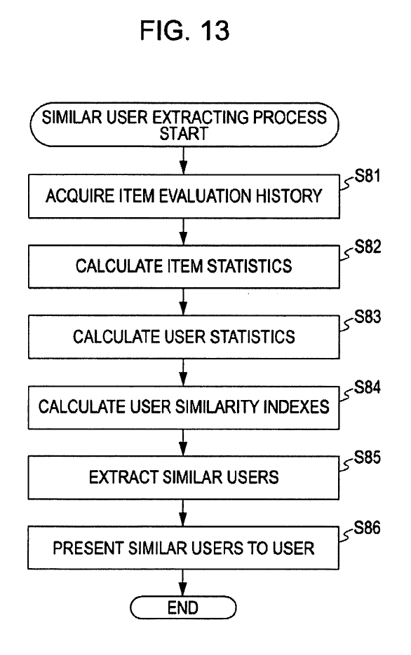

As will be described later with reference to FIG. 13 and the like, the user similarity index calculating section 38 calculates user similarity indexes indicating similarity indexes among users on the basis of user statistics. The user similarity index calculating section 38 supplies information indicating the calculated user similarity indexes to the similar user extracting section 39 and the predicted evaluation value calculating section 40, as necessary.

As will be described later with reference to FIG. 13 and the like, the similar user extracting section 39 extracts similar users similar to individual users on the basis of the user similarity indexes. The similar user extracting section 39 supplies information indicating the similar users for individual users to the recommended item extracting section 41 and the information presenting section 42, as necessary.

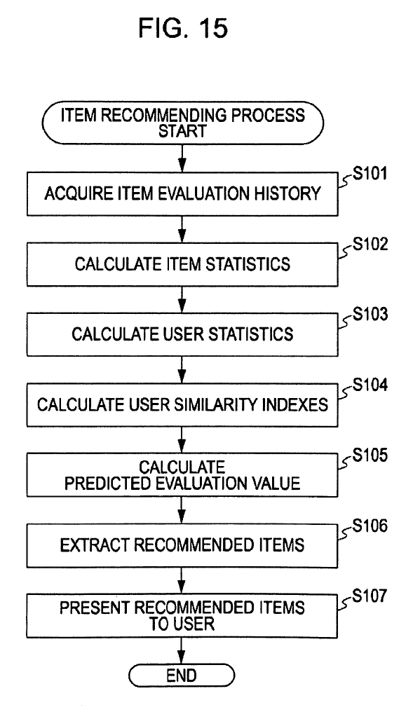

As will be described later with reference to FIG. 15 and the like, the predicted value calculating section 40 calculates a predicted evaluation value that is a predicted value of an evaluation value on an item that has not been evaluated by the user. The predicted evaluation value calculating section 40 supplies information indicating the calculated predicted evaluation value to the recommended item extracting section 41.

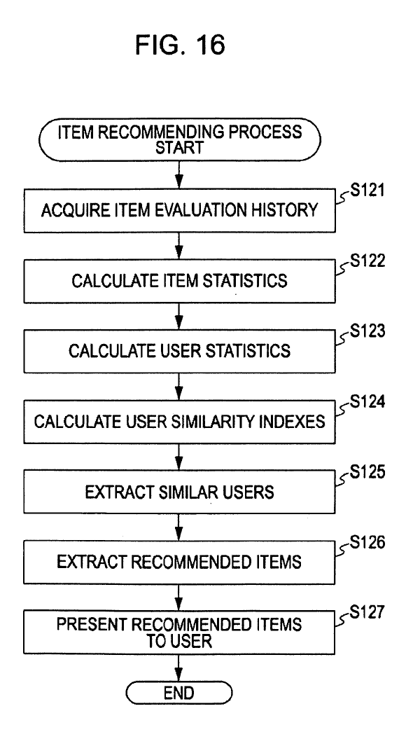

As will be described later with reference to FIGS. 15, 16, and the like, the recommended item extracting section 41 extracts recommended items to be recommended to individual users, on the basis of a predicted evaluation value, an item evaluation history, and information related to similar users. The recommended item extracting section 41 supplies information indicating the extracted recommended items to the information presenting section 42.

The information presenting section 42 controls the recording of information related to individual items to the item information holding section 43, and the recording of information related to individual users to the user information holding section 44. Also, in response to a commend for presenting items and various kinds of information, which is inputted via the input section 21 of the user interface section 11, the information presenting section 42 acquires the requested items and information from the item information holding section 43 and the user information holding section 44, and transmits the acquired items and information to the display section 22, thereby controlling the presentation of items and various kinds of information to the user.

It should be noted that the user interface section 11 and the information processing section 12 may be configured by a single device, or may be configured as separate devices. In the case where the user interface section 11 and the information processing section 12 are configured by separate devices, the user interface section 11 is configured by a user terminal such as a personal computer, a mobile telephone, or consumer electronics equipment, and the information processing section 12 is configured by a server such as a Web server or an application server. In this case, in the information processing system 1, a plurality of user interface sections 11 are connected to the information processing section 12 via a network such as the Internet. It is also possible to configure the information processing section 12 by a plurality of devices.

In the following, a description will be given of a case in which the user interface section 11 is configured by a user terminal, and the information processing section 12 is configured by a server.

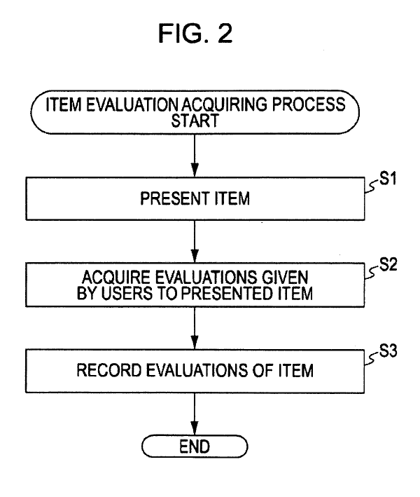

Next, referring to FIGS. 2 to 16, processing executed by the information processing system 1 will be described.

First, referring to the flowchart in FIG. 2, a description will be given of an item evaluation acquiring process executed by the information processing system 1. This process is started when, for example, the user inputs a command for presentation of a desired item via the input section 21 of the user interface section 11, and the command is transmitted to the information presenting section 42 of the information processing section 12.

In step S1, the display section 22 presents an item. Specifically, the information presenting section 42 acquires information related to the item requested by the user, from the item information holding section 43, and transmits the information to the display section 22 of the user interface section 11. On the basis of the received information, the display section 22 displays the information related to the item requested by the user. For example, if the item requested by the user is a music album, an artist name, an album title, a song title, a test listening sample, review text on the album, and the like are displayed.

In step S2, the item evaluation acquiring section 31 acquires an evaluation given to the presented item by the user. Specifically, for example, after test listening, purchase, trial use, or use of the presented item, the user inputs an evaluation on the item via the input section 21. Examples of an evaluation inputted at this time include an evaluation value as a numerical representation of an evaluation given to the item, and review test. Also, an evaluation value is directly inputted by the user, or is inputted by the user making a selection from among choices such as “satisfied” “somewhat satisfied” “neutral”, “somewhat dissatisfied”, and “dissatisfied”.

Instead of the user directly inputting an evaluation value, an evaluation value may be determined on the information processing system 1 side on the basis of the user's item usage history or the like. For example, a configuration is conceivable in which if a user has taken an action that suggests that the user evaluates an item highly, such as when the user uses a specific item repeatedly, or when the user presets a recording of the item in the case of a TV program information page, a user's evaluation value for the item may be automatically set to a high value.

The input section 21 transmits information indicating the inputted evaluation of the item to the item evaluation value acquiring section 31, and the item evaluation acquiring section 31 acquires the transmitted information.

In step S3, the item evaluation acquiring section 31 records the acquired evaluation of the item. That is, the item evaluation acquiring section 31 records the acquired evaluation of the item to an item evaluation history held in the history holding section 32. Thereafter, the item evaluation acquiring process ends. As this item evaluation acquiring section is repeated, histories of evaluations given to individual items by individual users are accumulated in the item evaluation history.

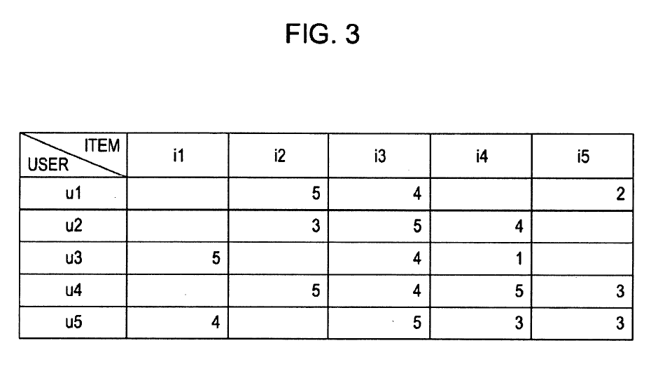

FIG. 3 shows an example of an item evaluation history related to evaluation values, in a case where there are five users u1 to u5 of the information processing system 1, five items i1 to i5 are handled by the information processing system 1, and an evaluation value of each individual item is represented on a scale of 5 from 1 as the lowest to 5 as the highest. The value in each column of the item evaluation history in FIG. 3 indicates an evaluation given to an item corresponding to that column by a user corresponding to that column. For example, in FIG. 3, an evaluation value given to the item i2 by the user u1 is 5, and an evaluation value given to the item i5 by the user u5 is 3. Each blank column in the item evaluation history indicates that a user corresponding to that column has not evaluated an item corresponding to that column.

In the following, a description will be given specifically of a process in a case where the item evaluation history in FIG. 3 is held by the history holding section 32.

Next, referring to the flowchart in FIG. 4, a description will be given of an item characteristic calculating process executed by the information processing system 1.

In step S21, the item statistics calculating section 33 acquires an item evaluation history held by the history holding section 32.

In step S22, the item statistics calculating section 33 calculates item statistics on the basis of the item evaluation history. The item statistics include at least three statistics, the number of evaluations Ni indicating the number of evaluations that have been given, an evaluation average avg(Ri) indicating the average of evaluation values, and an evaluation variance var(Ri) indicating the variance of evaluation values.

The number of evaluations Ni indicates the degree of interest a user group has in the item. Generally, the number of evaluations given to individual items exhibits a so-called long tail tendency, such that a large number of evaluations center on a fairly small number of popular items, and a small number of evaluations are given to other broad range of items. Accordingly, instead of the number of evaluations Ni, the logarithm log Ni or the like of the number of evaluations Ni may be used. Hereinafter, the logarithm log Ni of the number of evaluations Ni will be also referred to as majorness index Mi.

The evaluation average avg(Ri) serves as a criterion by which to determine whether an item in question is good or bad.

The evaluation variance var(Ri) indicates the variation of evaluation of an item in question among users.

FIG. 5 shows item statistics calculated on the basis of the item evaluation history in FIG. 3. The second row in FIG. 5 shows the number of evaluations Ni and majorness index Mi (number in brackets) for each individual item, the third row shows the evaluation average avg(Ri) for each individual item, and the fourth row shows the evaluation variance var(Ri) for each individual item. For example, in FIG. 5, for the item i1, the number of evaluations Nl is 2, the majorness index Ml is 0.69, the evaluation average avg(Rl) is 4.5, and the evaluation variance var(Rl) is 0.25.

The item statistics calculating section 33 repeats a process of selecting one item that is to be noted (hereinafter, referred to as noted item) and calculating the item statistics of the noted item, until all the items become noted items, thereby calculating the item statistics of individual items. The item statistics calculating section 33 supplies information indicating the calculated item statistics of individual items to the item type determining section 34.

In step S23, the item type determining section 34 obtains the ranks or sets of individual items on the basis of the item statistics. Specifically, for example, the item type determining section 34 ranks items in accordance with each of the statistics (the number of evaluations Ni, the evaluation average avg(Ri), and the evaluation variance var(Ri)) included in the item statistics.

FIG. 6 shows the ranks of items when ranked on the basis of the item statistics in FIG. 5. The second row in FIG. 6 shows ranks Pni when items are arranged in ascending order of the number of evaluations Ni, the third row shows ranks Pai when items are arranged in ascending order of the evaluation average avg(Ri), and the fourth row shows ranks Pvi when items are arranged in ascending order of the evaluation variance var(Ri). For example, in FIG. 6, the rank of the item i1 in the number of evaluations is 1, its rank Pal in evaluation average is 5, and its rank Pvl in valuation variance is 3.

Alternatively, for example, the item type determining section 34 groups items by each of the statistics (the number of evaluations Ni, the evaluation average avg(Ri), and the evaluation variance var(Ri)) included in the item statistics, by using an arbitrary threshold. For example, the item type determining section 34 groups items by using the number of evaluations Ni into a set of major items Smj with the number of evaluations Ni equal to or larger than a threshold, and a set of minor items Smn with the number of evaluations Ni less than the threshold, groups items by using the evaluation average avg(Ri) into a set of high evaluation items Sah with the evaluation averages avg(Ri) equal to or larger than a threshold, and a set of low evaluation items Sal with the evaluation averages avg(Ri) less than the threshold, or groups items by using the evaluation variance var(Ri) into a set of items with large variations in evaluation Svh with the evaluation variance var(Ri) equal to or larger than a threshold, and a set of items with small variations in evaluation Svl with the evaluation variance var(Ri) less than the threshold.

In step S24, the item type determining section 34 determines an item type. For example, in a case where ranking of items is performed in step S23, the item type determining section 34 determines the item type of each individual item by appropriately combining the obtained ranks. For example, the item type determining section 34 determines a masterpiece index MPi of each individual item from Equation (1) below.

Masterpiece index MPi=rank in the number of evaluation numbers Pni+rank in evaluation average Pai−or rank in evaluation variance Pvi (1)

That is, the masterpiece index MPi becomes larger as the number of evaluations becomes larger, the evaluation average becomes higher, and the evaluation variance becomes smaller. Therefore, an item with a high masterpiece index MPi receives a high average evaluation from a large number of people. The item type determining section 34 determines the item type of an item whose masterpiece index MPi is equal to or higher than a predetermined threshold, for example, as “masterpiece”.

Also, for example, the item type determining section 34 determines a hidden masterpiece index SMPi of each individual item from Equation (2) below.

Hidden masterpiece index SMPi=−rank in the number of evaluations Pni+rank in evaluation average Pai (2)

That is, the hidden masterpiece index SMPi becomes larger as the number of evaluations becomes smaller, and the evaluation average becomes higher. Therefore, an item with a high masterpiece index SMPi receives a high average evaluation from a small number of people. The item type determining section 34 determines the item type of an item whose hidden masterpiece index SMPi is equal to or higher than a predetermined threshold, for example, as “hidden masterpiece”.

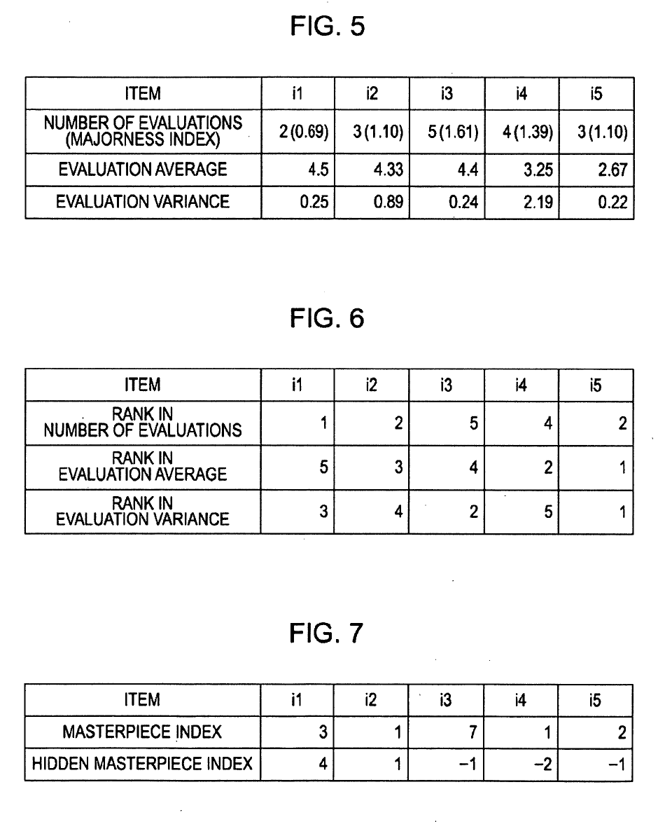

FIG. 7 shows the masterpiece index MPi and hidden masterpiece index SMPi of each individual item based on the ranks of items in FIG. 6. The second row in FIG. 7 shows the masterpiece index MPi of each individual item, and the third row shows the hidden masterpiece index SMPi of each individual item. For example, in FIG. 7, the masterpiece index MPl of the item i1 is 3, and its hidden masterpiece index SMPl is 4.

Also, for example, in a case where grouping of items is performed in step S23, the item type determining section 34 determines the item types of individual items through a combination of sets to which the individual items belong. For example, since an item included in a product set Smj∩Sah∩Svl has a large number of evaluations Ni, a high evaluation average avg(Ri), and a small evaluation variance var(Ri), the item type determining section 34 determines the item type of that item as “masterpiece”. Also, since an item included in a product set Smn∩Sah has a small number of evaluations Ni and a high evaluation average avg(Ri), the item type determining section 34 determines the item type of that item as “hidden masterpiece”.

The item type determining section 34 repeats a process of selecting one noted item and determining the item type of the noted item, until all the items become noted items, thereby determining the item types of individual items. The item type determining section 34 supplies information indicating the determined item types of individual items to the information presenting section 42. The information presenting section 42 adds the determined item types of individual items to the information of individual items held by the item information holding section 43.

In step S25, the information presenting section 42 presents an item type to the user. For example, when presenting information of an item to the user through the same processing as that of step S1 in FIG. 2, the information presenting section 42 also transmits information indicating the item type of the item to the display section 22. The display section 22 displays the item type of the item (for example, “masterpiece”, “hidden masterpiece”, or the like), together with the information of the item requested by the user.

In this way, by making effective use of users' evaluations given to individual items, it is possible to appropriately determine the item type of each individual item, and presents the determined item type to the user. Thus, the user can learn the tendency of evaluations given to each individual item.

Next, referring to the flowchart in FIG. 8, a description will be given of a similar item extracting process executed by the information processing system 1.

In step S41, as in the processing of step S21 in FIG. 4, the item statistics calculating section 33 acquires an item evaluation history. Then, in step S42, as in the processing of step S22 in FIG. 4, the item statistics calculating section 33 calculates item statistics, and supplies information indicating the calculated item statistics to the item similarity index calculating section 35.

In step S43, the item similarity index calculating section 35 calculates item similarity indexes. For example, the item similarity index calculating section 35 calculates the item similarity index Sim(i, j) between an item i and an item j by using a function that monotonically decreases with respect to the difference between the majorness index Mi of the item i and the majorness index Mj of the item j.

Sim(i, j)=1/(|Mi−Mj|+ε) (ε is a positive constant) (3)

That is, the item similarity index Sim(i, j) obtained from Equation (3) becomes larger as the difference in majorness index between items |Mi−Mj| becomes smaller, indicating that the two items are similar to each other.

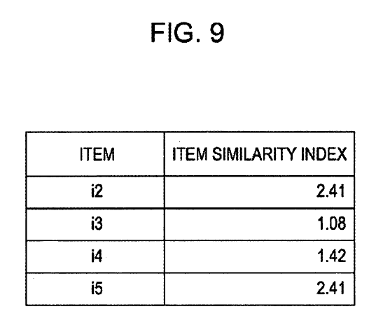

FIG. 9 shows the similarity index Sim(l, j) between the item i1 and each of other individual items, as calculated by using Equation (3) on the basis of the majorness index Mi in FIG. 5, with ε set equal to 0.01. For example, in FIG. 9, the item similarity index Sim(1, 2) between the item i1 and the item i2 is 2.41, the item similarity index Sim(1, 3) between the item i1 and the item i3 is 1.08, the item similarity index Sim(1, 4) between the item i1 and the item i4 is 1.42, and the item similarity index Sim(1, 5) between the item i1 and the item i5 is 2.41.

It is also possible to calculate the item similarity index Sim(i, j) by defining the vector of an item i as vi=(Mi, avg(Ri), var(Ri)) and the vector of an item j as vj=(Mj, avg(Rj), var(Rj)), and using a function that monotonically decreases with respect to the Euclidean distance between the vector vi and the vector vj (for example, the inverse of the Euclidean distance), or to calculate the cosine similarity index between the vector vi and the vector vj as the item similarity index Sim(i, j). In this case, the tendencies of distribution of the values of individual elements (the majorness index, the evaluation average, and the evaluation variance) constituting the vectors vi and vj differ from each other. Thus, for individual elements, values normalized so that the average becomes 0 and the variance becomes 1 may be set as the values of the individual elements of the vectors vi and vj.

The item similarity index calculating section 35 repeats a process of selecting one noted item and calculating the item similarity index Sim(i, j) between the noted item and another item while changing the noted item, until the item similarity indexes Sim(i, j) among all the items are calculated. The item similarity index calculating section 35 supplies the calculated item similarity indexes Sim(i, j) to the similar item extracting section 36.

A new item similarity index Sim′ (i, j) may be obtained by using not only item statistics but also information related to each individual item. For example, if an item is a document, a configuration is conceivable in which word vectors are created with the frequencies of occurrence of individual words in individual items as elements, and a new item similarity index Sim′ (i, j) is calculated from Equation (4) below by using the cosine distance Cos(i, j) between word vectors, and the above-described item similarity index Sim(i, j) based on the item statistics.

Sim′(i, j)=Cos(i, j)+Sim(i, j) (4)

In step S44, the similar item extracting section 36 extracts similar items. For example, the similar item extracting section 36 repeats a process of selecting one noted item, and extracting items whose item similarity indexes Sim(i, j) to the noted item are equal to or higher than a predetermined threshold, for example, as similar items for the noted item, until all the items become noted items, thereby extracting similar items for individual items.

Alternatively, the similar item extracting section 36 repeats a process of extracting, as similar items for a noted item, the top N items when items are sorted in descending order of the item similarity index Sim(i, j) to the noted item, until all the items become noted items, thereby extracting similar items for individual items. For example, if N=2 in the case of the item similarity indexes in FIG. 9, the item i2 and the item i5 with the highest two similarity indexes Sim(l, j) are extracted as similar items for the item i1.

The similar item extracting section 36 supplies information indicating the extracted similar items for individual items to the information presenting section 42. The information presenting section 42 adds information of the extracted similar items for individual items to the information of individual items held by the item information holding section 43.

In step S45, the information presenting section 42 presents similar items to the user. For example, when presenting information of an item to the user through the same processing as that of step S1 in FIG. 2 described above, the information presenting section 42 also transmits information indicating similar items for the item to the display section 22. The display section 22 displays, together with information related to the item requested by the user, information related to the similar items for the item.

In this way, by making effective use of users' evaluations given to individual items, items with similar tendencies of evaluations can be appropriately extracted for presentation to the user.

While the above description is directed to a case where, for every item, its item similarity index to another item is calculated and similar items are extracted, this processing may be performed only for necessary items, for example, requested items. Also, the range of similar items to be extracted may be restricted by using various conditions (for example, genre, release date, and the like).

Next, referring to the flowchart in FIG. 10, a description will be given of a user characteristic calculating process executed by the information processing system 1.

In step S61, as in the processing of step S21 in FIG. 4, the item statistics calculating section 33 acquires an item evaluation history. Then, in step S62, as in the processing of step S22 in FIG. 4, the item statistics calculating section 33 calculates item statistics, and supplies information indicating the calculated item statistics to the user statistics calculating section 37.

In step S63, the user statistics calculating section 37 calculates user statistics. Now, an example of statistics included in the user statistics will be described.

For example, the average avg_u(Mi) and variance var_u(Mi) of the majorness indexes Mi of items included in a set Cu of items that have been evaluated by a noted user u serves as an index of to what kinds of items the user u give evaluations. In particular, the average avg_u(Mi) of majorness indexes Mi indicate the average of the numbers of evaluations Ni given to items that have been evaluated by the user u. If this value is large, it can be said that the user u tends to be interested in popular items, and if this value is small, it can be said that the user u tends to be interested in items that are not popular. That is, it can be said that the average avg_u(Mi) of majorness indexes Mi indicates the fad chaser level of a user. Thus, hereinafter, the average avg_u(Mi) of majorness indexes Mi will be also referred to as fad chaser index MHu. Also, hereinafter, the variance var_u(Mi) of majorness indexes Mi will be referred to as majorness index variance var_u(Mi).

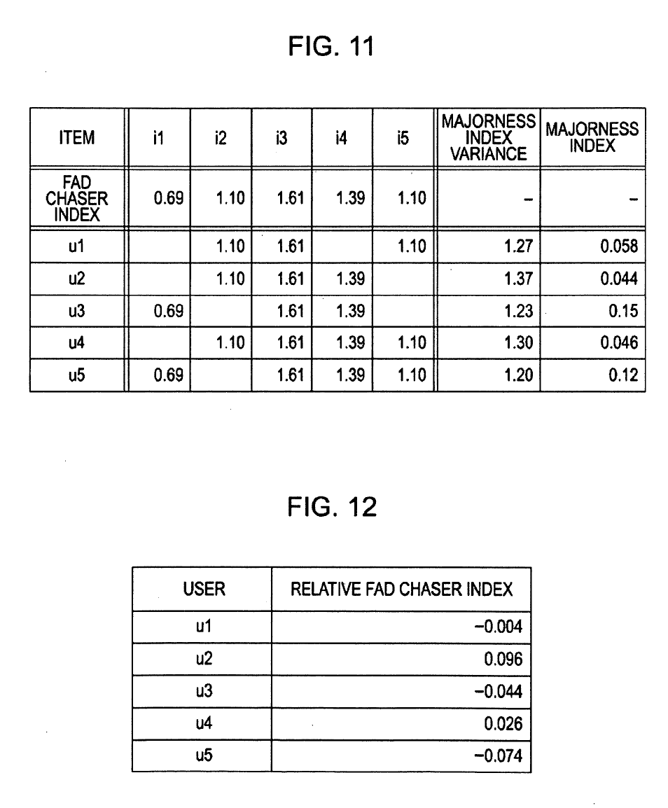

FIG. 11 shows the fad chaser index MHu and majorness index variance var_u(Mi) of each individual user as calculated on the basis of the item evaluation history in FIG. 3 and the item statistics in FIG. 5. The second row in FIG. 11 shows the majorness indexes Mi of items i1 to i5, the second to sixth columns in the third to seventh rows show the majorness indexes Mi of items that have been evaluated by users u1 to u5, the seventh column in the third to seventh rows show the fad chaser indexes MHu of the users u1 to u5, and the eighth column in the third to seventh rows show the majorness index variances var_u(Mi) of the users u1 to u5. For example, in FIG. 11, the fad chaser index MHl of the user u1 is 1.27, and the majorness index variance var_l(Mi) is 0.058.

Also, the coefficient of correlation Cor(Rui, Mi) between an evaluation value Rui given by the user u to an item included in the set Cu and the majorness index Mi of the item indicates a correlation between the evaluation value Rui given by the user u to an item that has been evaluated by the user u and the average of the numbers of evaluations Ni (more precisely, the average of the logarithms of the numbers of evaluations Ni) serves as an index of to what type of item the user u tends to give a high evaluation. For example, if the coefficient of correlation Cor(Rui, Mi) is large, this means that the user u tends to give a high evaluation to an item that attracts interest of many people. Thus, it can be said that the user u has a majorness orientation or a follower-like characteristic.

Further, the coefficient of correlation Cor (Rui, avg(Ri)) between the evaluation value Rui given by the user u to an item included in the set Cu and the evaluation average avg(Ri) for the item serves as an index of whether or not the user u is an average user. For example, if the coefficient of correlation Cor(Rui, avg(Ri)) is large, it can be said that the user u is highly ordinary, that is, has an average sense of values.

The user statistics calculating section 37 repeats a process of selecting one user to be noted (hereinafter, referred to as noted user) and calculating the user statistics of the noted user, until all the users become noted users, thereby calculating the user statistics of individual users.

As the user statistics, all of the above-described fad chaser index MHu, the majorness index variance var_u(Mi), and the coefficient of correlation Cor(Rui, Mi) may be calculated, or only necessary one(s) of these values may be calculated.

In step S64, the user statistics calculating section 37 calculates user relative statistics. Now, an example of relative statistics included in the user relative statistics will be described.

For example, a relative fad chaser index MHu-avg(MHu) as a deviation of the fad chaser index MHu of a noted user from the average avg(MHu) of the fad chaser indexes of all users indicates the fad chaser level of the noted user is relative to all users. For example, it can be said that a user with a large relative fad chaser index MHu-avg(MHu) has a particularly strong fad-chasing characteristic among all users.

FIG. 12 shows the relative fad chaser index of each individual user calculated on the basis of the fad chaser index in FIG. 11. For example, in FIG. 12, the relative fad chaser index MHl-avg(MHu) of the user u1 is −0.004.

The user statistics calculating section 37 repeats a process of selecting one noted user and calculating the user relative statistics of the noted user, until all the users become noted users, thereby calculating the user relative statistics of individual users. Then, the user statistics calculating section 37 supplies information indicating the user statistics and user relative statistics of individual users to the information presenting section 42. The information presenting section 42 adds the acquired user statistics and user relative statistics to the information of individual users held by the user information holding section 44.

In step S65, the information presenting section 42 presents the characteristics of a user to a user on the basis of the user statistics and user relative statistics. For example, when a command for presenting information related to a user A is inputted via the input section 21, the information presenting section 42 obtains the characteristics of the user A on the basis of the user statistics and user relative statistics, and adds the obtained characteristics of the user A to information of the user A and transmits the information to the display section 22. The display section 22 displays the characteristics of the user A together with the requested information of the user A. For example, on the My Page of the SNS (Social Networking Service) which shows a profile or the like of the user A, a display such as “Fad chaser index of the user A: ★★★★⋆” is made on the basis of the fad chaser index MHu or the relative fad chaser index MHu-avg(MHu).

In this way, by making effective use of users' evaluations given to individual items, the characteristics of individual users can be accurately obtained for presentation to the user.

Next, referring to the flowchart in FIG. 13, a description will be given of a similar user extraction process executed by the information processing system 1.

In step S81, as in the processing of step S21 in FIG. 4, the item statistics calculating section 33 acquires an item evaluation history. Then, in step S82, as in the processing of step S22 in FIG. 4, the item statistics calculating section 33 calculates item statistics, and supplies information indicating the calculated item statistics to the user statistics calculating section 37.

In step S83, as in the processing of step S63 in FIG. 10, the user statistics calculating section 37 calculates user statistics, and supplies information indicating the calculated user statistics to the user similarity index calculating section 38.

In step S84, the user similarity index calculating section 38 calculates user similarity indexes on the basis of the user statistics. For example, by assuming that the majorness indexes Mi of items included in a set of items that have been evaluated by individual users are in a normal distribution, the user similarity index calculating section 38 calculates, as an inter-user distance D(u, v) between a user u and a user v, the KL distance (Kullback-Leibler divergence) between the distribution of the majorness indexes Mi of items included in the set Cu of items that have been evaluated by the user u, and the distribution of the majorness indexes Mi of the set Cv of items that have been evaluated by the user v, from Equation (5) below.

$$D ( u , v ) = \frac{1}{2} ( log ( \frac{{σ}_{v}^{2}}{{σ}_{u}^{2}} ) + \frac{{σ}_{u}^{2}}{{σ}_{v}^{2}} + \frac{{( {μ}_{v} - {μ}_{u} )}^{2}}{{σ}_{v}^{2}} - 1 ) \qquad ( 5 )$$

In Equation (5), μ_{μ} denotes the average avg_u(Mi) of the majorness indexes Mi of items in the set Cu of items that have been evaluated by the user u (that is, the fad chaser index MHu), σ_{μ}² denotes the majorness index variance var_u(Mi) of items in the set Cu, μᵥ denotes the average avg_v(Mi) of the majorness indexes Mi of items in the set Cv of items that have been evaluated by the user v (that is, the fad chaser index MHv), and σᵥ² denotes the majorness index variance var_v(Mi) of items in the set Cv.

Since the KL distance does not become symmetrical with respect to u and v, (D(u, v)+D(v, u))/2 may be obtained as the inter-user distance between the user u and the user v.

Then, the user similarity index calculating section 38 calculates the user similarity index SimU(u, v) between the user u and the user v by using a function that monotonically decreases with respect to the inter-user distance D(u, v), as in Equation (6) below.

SimU(u, v)=1−D(u, v) (6)

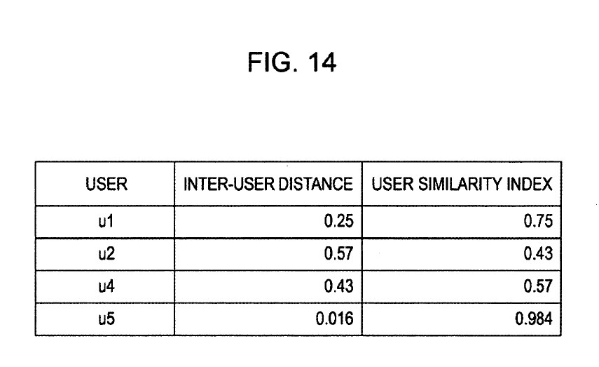

FIG. 14 shows the inter-user distances D(u, v) and user similarity indexes SimU(u, v) between the user u3 and other users as calculated by Equation (5) and Equation (6) described above, on the basis of the user statistics in FIG. 11. For example, in FIG. 14, the inter-user distance D(3,1) between the user u3 and the user u1 is 0.25, and the user similarity index SimU(3,1) is 0.75.

The user similarity index calculating section 38 repeats a process of selecting one noted user and calculating the inter-user distance D(u, v) and the user similarity index SimU(u, v) between the noted user and another user, while varying the noted user, until the user distances D(u, v) and the user similarity indexes SimU(u, v) among all the other users are calculated. The user similarity index calculating section 38 supplies information indicating the calculated user similarity indexes SimU(u, v) to the similar user extracting section 39.

In step S85, the similar user extracting section 39 extracts similar users. For example, the similar user extracting section 39 repeats a process of selecting one noted user, and extracting users whose user similarity indexes SimU(u, v) to the noted user are equal to or higher than a predetermined threshold, for example, as similar users for the noted user, until all the users become noted users, thereby extracting similar users for individual users. Alternatively, the similar user extracting section 39 repeats a process of extracting, as similar users for a noted user, the top N ones of users sorted in descending order of the user similarity index SimU(u, v) to the noted user, until all the users become noted users, thereby extracting similar users for individual users.

The similar user extracting section 39 supplies information indicating the extracted similar users for individual users to the information presenting section 42. The information presenting section 42 adds the information of the extracted similar users for individual users to the information of individual users held by the user information holding section 44.

In step S86, the information presenting section 42 presents similar users to a user. For example, when a command for presenting information related to the user A is inputted via the input section 21, the information presenting section 42 transmits information indicating similar users for the user A to the display section 22, together with the information of the user A. The display section 22 displays the similar users for the user A together with the requested information of the user A. For example, a list of similar users is displayed as “Users similar to the user A” on the My Page of the SNS (Social Networking Service) which shows a profile or the like of the user A.

In this way, by making effective use of users' evaluations given to individual items, users who tend to give similar evaluations to items, in other words, users with similar values and preferences can be appropriately extracted for presentation to the user.

While the above description is directed to a case where, for every item, its item similarity index to another item is calculated and similar items are extracted, this processing may be performed only for necessary users, for example, requested users. Also, the range of similar users to be extracted may be restricted by using various conditions (for example, sex, age, and address).

Next, referring to the flowchart in FIG. 15, a description will be given of an item recommending process executed by the information processing system 1.

In step S101, as in the processing of step S21 in FIG. 4, the item statistics calculating section 33 acquires an item evaluation history. Then, in step S102, as in the processing of step S22 in FIG. 4, the item statistics calculating section 33 calculates item statistics, and supplies information indicating the calculated item statistics to the user statistics calculating section 37.

In step S103, as in the processing of step S63 in FIG. 10, the user statistics calculating section 37 calculates user statistics, and supplies information indicating the calculated user statistics to the user similarity index calculating section 38.

In step S104, as in the processing of step S84 in FIG. 10, the user similarity index calculating section 38 calculates user similarity indexes, and supplies information indicating the calculated user similarity indexes to the predicted evaluation value calculating section 40.

In step S105, the predicted evaluation value calculating section 40 calculates a predicted evaluation value. For example, a predicted evaluation value Rui′ for a user u with respect to an item i that has not been evaluated by the user u is calculated on the basis of Equation (7) below by using a user similarity index SimU(u, v).

$${R}_{ui}^{′} = {avg\_R}_{u} + \frac{{\sum }_{v} ( {R}_{vi} - {avg\_R}_{v} ) SimU ( u , v )}{{\sum }_{v} \vert SimU ( u , v ) \vert} \qquad ( 7 )$$

In Equation (7), ave_Ru denotes the average of evaluation values given by the user u to items included in a set Cu of items that have been evaluated by the user u, avg_Rv denotes the average of evaluation values given by a user v to items included in a set Cv of items that have been evaluated by the user v, and Rvi denotes an evaluation value given to the item i by the user v. In Equation (7), data of users who have not evaluated the item i is not used.

According to Equation (7), a large weight is assigned to the evaluation value Rvi of a user with a large similarity index SimU(u, v) to the user u, and a small weight is assigned to the evaluation value Rvi of a user with a small similarity index SimU(u, v) to the user u. Thus, the evaluation value Rvi given to the item i by the user with a large similarity index SimU(u, v) to the user u is reflected more greatly on the predicted evaluation value Rui′.

It should be noted that in the example disclosed in P. Resnick, N. Iacovou, M. Suchak, P. Bergstrom, and J. RIedl. “GroupLens: Open Architecture for Collaborative FilterIng of Netnews.” Conference on Computer Supported Cooperative Work, pp. 175-186, 1994 described above, instead of SimU(u, v) in Equation (7), the Pearson correlation coefficient with respect to the evaluation values between the user u and the user v is used.

The predicted value calculating section 40 repeats a process of selecting one noted user, selecting one noted item from among items that have not been evaluated by the noted user, and calculating the predicted evaluation value Rui′ for the noted user with respect to the noted item, until all the items that have not been evaluated by the noted user become noted items, and until all the users become noted users, thereby calculating predicted evaluation values for individual users with respect to individual items that have not been evaluated. The predicted value calculating section 40 supplies information indicating the predicted evaluation values Rui′ to the recommended item extracting section 41.

In step S106, the recommended item extracting section 41 extracts recommended items. For example, the recommended item extracting section 41 repeats a process of selecting one noted user and extracting, as recommended items, items for which the predicted evaluation values Rui′ of the noted user are equal to or higher than a predetermined threshold, until all the users become noted users, thereby extracting recommended items for individual users. Also, for example, the recommended item extracting section 41 repeats a process of selecting one noted user, and extracting as recommended items the top N ones of items sorted in descending order of the predicted evaluation value Rui′ of the noted user, until all the users become noted users, thereby extracting recommended items for individual users.

The recommended item extracting section 41 supplies information indicating the recommended items for individual users to the information presenting section 42. The information presenting section 42 adds the information of the extracted recommended items to the information of individual users held by the user information holding section 44.

In step S107, the information presenting section 42 presents recommended items to the user. For example, as necessary, the information presenting section 42 transmits information indicating recommended items for a user who is the owner of the user interface section 11, to the display section 22. The display section 22 displays a list of the recommended items.

In this way, by making effective use of users' evaluations given to individual items, appropriate items can be recommended to individual users.

Next, referring to the flowchart in FIG. 16, a second embodiment of an item recommending process will be described.

In step S121, as in the processing of step S21 in FIG. 4, the item statistics calculating section 33 acquires an item evaluation history. Then, in step S122, as in the processing of step S22 in FIG. 4, the item statistics calculating section 33 calculates item statistics, and supplies information indicating the calculated item statistics to the user statistics calculating section 37.

In step S123, as in the processing of step S63 in FIG. 10, the user statistics calculating section 37 calculates user statistics, and supplies information indicating the calculated user statistics to the user similarity index calculating section 38.

In step S124, as in the processing of step S84 in FIG. 10, the user similarity index calculating section 38 calculates user similarity indexes, and supplies information indicating the calculated user similarity indexes to the similar user extracting section 39.

In step S125, as in the processing of step S85 in FIG. 13, the similar user extracting section 39 extracts similar users, and supplies information indicating the extracted similar users to the recommended item extracting section 41.

In step S126, the recommended item extracting section 41 extracts recommended items. Specifically, the recommended item extracting section 41 acquires an item evaluation history held by the history holding section 32. The recommended item extracting section 41 repeats a process of selecting one noted user, and extracting items to which high evaluation values are given by similar users for the noted user as recommended items, from among items that have not been evaluated by the noted user, until all the users become noted users, thereby extracting recommended items for individual users. For example, an item for which the average or highest value of evaluation values given by similar users is equal to or greater than a predetermined threshold, an item for which the number or ratio of similar users who have given evaluation values equal to or greater than a predetermined threshold is equal to or greater than a predetermined threshold, and the like are extracted as recommended items for the noted user.

For example, in a case where the user u5 is selected as a similar user for the user u3 on the basis of the user similarity indexes SimU(u, v) in FIG. 14, if the threshold of the evaluation value used for extracting recommended items is 3, on the basis of the item evaluation history in FIG. 3, the item i5 whose evaluation value given by the user u5 is equal to or greater than 3 is selected from among items that have not been evaluated by the user u3, as a recommended item for the user u3.

The recommended item extracting section 41 supplies information indicating recommended items for individual users to the information presenting section 42. The information presenting section 42 adds the information of the extracted recommended items, to the information of individual users held by the user information holding section 44.

In step S127, as in the processing of step S107 in FIG. 15, recommended items are presented to the user.

In this way, by making effective use of users' evaluations given to individual items, appropriate items can be recommended to individual users.

As described above, by making effective use of users' evaluations given to individual items, it is possible to obtain the social positioning of individual items that may not be easily understood from descriptions (metadata) of the items, or the social positioning of individual users. Also, preferences of other, similar types of users are reflected, thereby making it possible to recommend items that better match user's preferences.

The above description is directed to a case where the information processing section 12 collects evaluations given to individual items by individual users. However, an embodiment is also conceivable in which, for example, the information processing section 12 acquires item evaluations collected by another device, and performs the above-described processing.

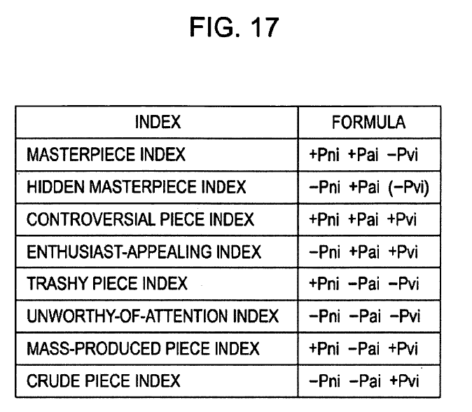

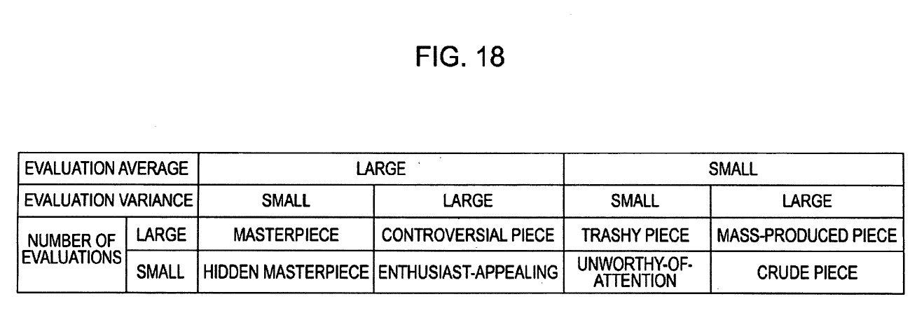

Now, referring to FIGS. 17 and 18, another example of item types will be described. FIG. 17 is a table summarizing formulae used to calculate individual indexes for determining item types. FIG. 18 is a table summarizing the relationship between the evaluation average, evaluation variance, and number of evaluations of an item, and each item type.

As described above, a masterpiece index is obtained by “rank in the number of evaluations Pni+rank in evaluation average Pai−rank in evaluation variance Pvi”. The masterpiece index becomes larger as the number of evaluations becomes larger, the evaluation average becomes higher, and the evaluation variance becomes smaller. That is, an item with a high masterpiece index is an item that receives high evaluations from a large number of users.

A hidden masterpiece index may be obtained not only by “−rank in the number of evaluations Pni+rank in evaluation average Pai” but also by “−rank in the number of evaluations Pni+rank in evaluation average Pai−rank in evaluation variance Pvi”. In the latter case, the hidden masterpiece index becomes larger as the number of evaluations becomes smaller, the evaluation average becomes higher, and the evaluation variance becomes smaller. That is, an item with a high hidden masterpiece index is an item that receives high evaluations, albeit from a small number of people.

A controversial piece index is obtained by “rank in the number of evaluations Pni+rank in evaluation average Pai+rank in evaluation variance Pvi”. The controversial piece index becomes larger as the number of evaluations becomes larger, the evaluation average becomes higher, and the evaluation variance becomes larger. That is, it can be said that an item with a high controversial piece index is an item that receives high evaluations from many people but its evaluations vary greatly from user to user, that is, an item that has been much talked about but receives mixed evaluations. The item type determining section 34 determines the item type of an item whose controversial piece index is equal to or greater than a predetermined threshold, for example, as “controversial piece”.

An enthusiast-appealing index is obtained by “−rank in the number of evaluations Pni+rank in evaluation average Pai+rank in evaluation variance Pvi”. The enthusiast-appealing index becomes larger as the number of evaluations becomes smaller, the evaluation average becomes higher, and the evaluation variance becomes larger. That is, it can be said that an item with a high enthusiast-appealing index is an item that receives high evaluations from a small number of people but its evaluations vary greatly from user to user, that is, an item that some people like. The item type determining section 34 determines the item type of an item whose enthusiast-appealing index is equal to or greater than a predetermined threshold, for example, as “enthusiast-appealing”.

A trashy piece index is obtained by “rank in the number of evaluations Pni−rank in evaluation average Pai−rank in evaluation variance Pvi”. The trashy piece index becomes larger as the number of evaluations becomes larger, the evaluation average becomes lower, and the evaluation variance becomes smaller. That is, it can be said that an item with a high trashy piece index is an item that receives a low average evaluation from a large number of people, that is, an item that has been much talked about but is of terrible quality. The item type determining section 34 determines the item type of an item whose trashy piece index is equal to or greater than a predetermined threshold, for example, as “trashy piece”.

A unworthy-of-attention index is obtained by “−rank in the number of evaluations Pni−rank in evaluation average Pai−rank in evaluation variance Pvi”. The unworthy-of-attention index becomes larger as the number of evaluations becomes smaller, the evaluation average becomes lower, and the evaluation variance becomes smaller. That is, it can be said that an item with a high unworthy-of-attention index is an item that receives a low average evaluation from a small number of people, that is, an item to which hardly anyone pays attention. The item type determining section 34 determines the item type of an item whose unworthy-of-attention index is equal to or greater than a predetermined threshold, for example, as “unworthy-of-attention”.

A mass-produced piece index is obtained by “+rank in the number of evaluations Pni−rank in evaluation average Pai+rank in evaluation variance Pvi”. The unworthy-of-attention index becomes larger as the number of evaluations becomes larger, the evaluation average becomes lower, and the evaluation variance becomes larger. That is, it can be said that an item with a high mass-produced piece index is an item that receives a low average evaluation from a large number of people but its evaluations vary greatly from user to user, that is, an item that has been much talked about but is of not quite so good a quality. The item type determining section 34 determines the item type of an item whose mass-produced piece index is equal to or greater than a predetermined threshold, for example, as “mass-produced piece”.

A crude piece index is obtained by “−rank in the number of evaluations Pni−rank in evaluation average Pai+rank in evaluation variance Pvi”. The crude index becomes larger as the number of evaluations becomes smaller, the evaluation average becomes lower, and the evaluation variance becomes larger. That is, it can be said that an item with a high crude piece index is an item that receives a low average evaluation from a small number of people, but its evaluations vary greatly from user to user, that is, an item that some people like despite its minorness. The item type determining section 34 determines the item type of an item whose crude piece index is equal to or greater than a predetermined threshold, for example, as “crude piece”.

Also, for example, the item type determining section 34 determines the item type of an item whose majorness index is equal to or greater than a predetermined threshold A as “major”, and determines the item type of an item whose majorness index is lower than the threshold A as “minor”.

In the following description, the coefficient of correlation Cor(Rui, Mi) between the evaluation value Rui of a user u and the majorness index Mi will be referred to as “majorness orientation index”, and the coefficient of correlation Cor(Rui,avg(Ri)) between the evaluation value Rui of the user u and the evaluation average avg(Ri) will be referred to as “ordinariness index”.

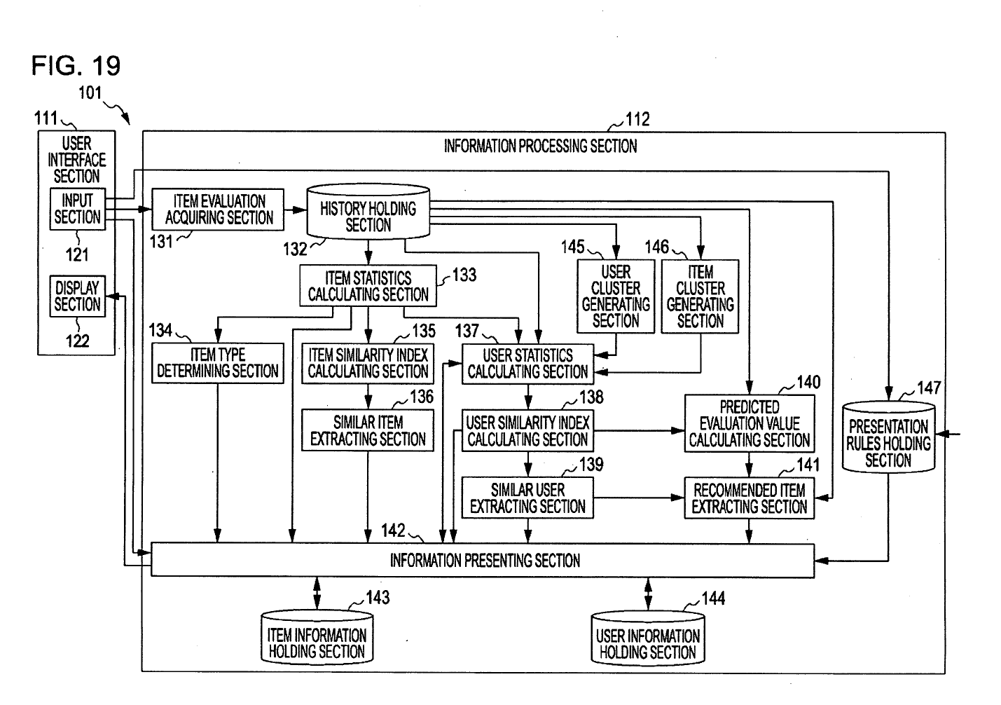

Next, referring to FIGS. 19 to 54, a second embodiment of the present invention will be described.

FIG. 19 is a block diagram showing an information processing system according to the second embodiment of the present invention. An information processing system 101 in FIG. 19 includes a user interface section 111 and an information processing section 112. The user interface section 111 includes an input section 121 and a display section 122. The information processing section 112 includes an item evaluation acquiring section 131, a history holding section 132, an item statistics calculating section 133, an item type determining section 134, an item similarity index calculating section 135, a similar item extracting section 136, a user statistics calculating section 137, a user similarity index calculating section 138, a similar user extracting section 139, a predicted evaluation value calculating section 140, a recommended item extracting section 141, an information presenting section 142, an item information holding section 143, a user information holding section 144, a user cluster generating section 145, an item cluster generating section 146, and a presentation rules holding section 147.

In the drawings, portions corresponding to those in FIG. 1 are denoted by reference numerals whose last two digits are the same as those in FIG. 1, and description of portions corresponding to similar processes is omitted to avoid repetition.

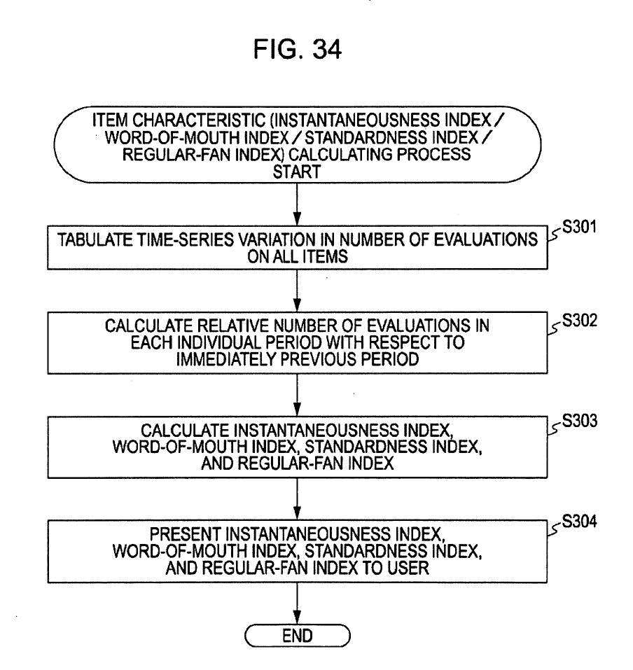

As will be described later with reference to FIG. 34 and the like, the item statistics calculating section 133 calculates item statistics indicating the tendency of evaluations given to each individual item, on the basis of item history information held by the history holding section 132. The item statistics calculating section 133 supplies information indicating the calculated item statistics to the item type determining section 134, the item similarity index calculating section 135, the user statistics calculating section 137, and the information presenting section 142, as necessary.

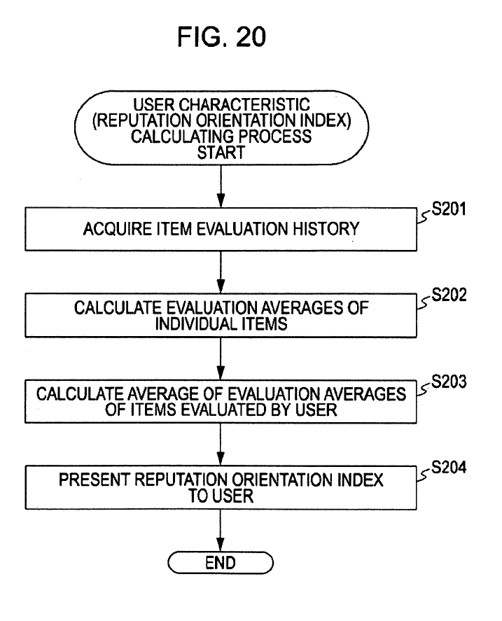

As will be described later with reference to FIG. 20 and the like, the user statistics calculating section 137 calculates user statistics indicating the characteristics of individual users according to the tendencies of evaluations given to individual items, on the basis of an item evaluation history held by the history holding section 132, item information acquired from the item information holding section 143 via the information presenting section 142, the item statistics supplied from the item statistics calculating section 133, user cluster information supplied from the user cluster generating section 145, and item cluster information supplied from the item cluster generating section 146. The user statistics calculating section 137 supplies information indicating the calculated user statistics to the user similarity index calculating section 138 and the information presenting section 142, as necessary.

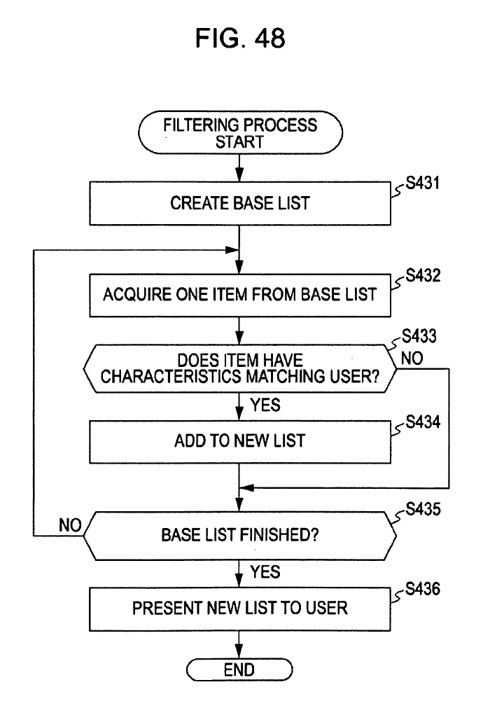

As will be described later with reference to FIG. 48 and the like, in addition to the processing of the recommended item extracting section 41 in FIG. 1, the recommended item extracting section 141 extracts items to be presented to individual users, on the basis of item information acquired from the item information holding section 143 via the information presenting section 142, and user information acquired from the user information holding section 144 via the information presenting section 142. The recommended item extracting section 141 supplies information indicating the extracted items to the information presenting section 142.

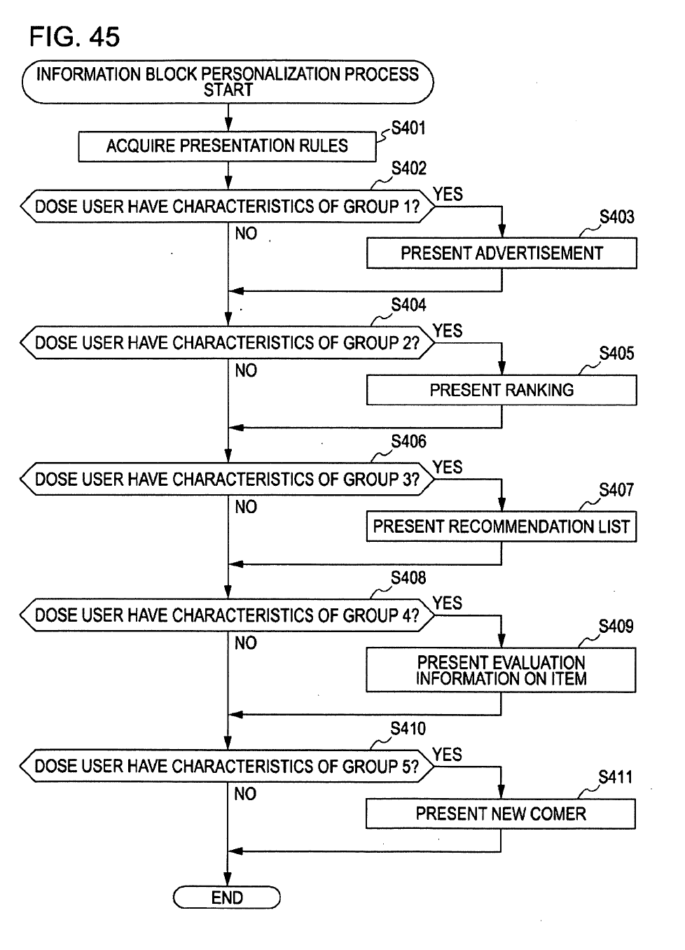

As will be described later with reference to FIG. 45 and the like, in addition to the processing of the information presenting section 42 in FIG. 1, the information presenting section 142 controls the presentation of information related to items via the display section 122, on the basis of presentation rules held by the presentation rules holding section 147, item information held by the item information holding section 143, and user information held by the user information holding section 144.

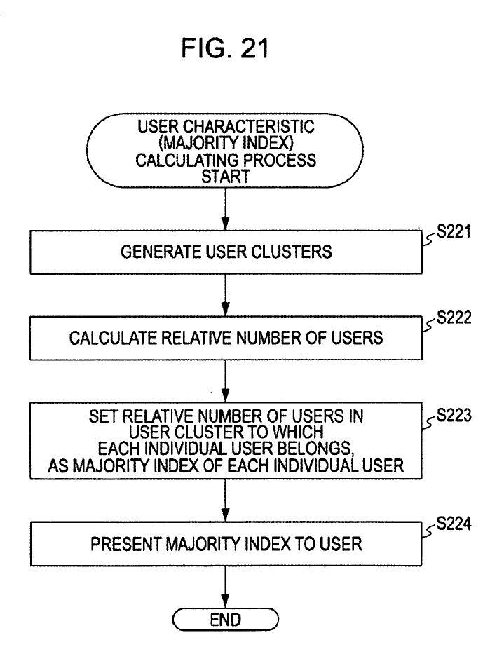

As will be described later with reference to FIG. 21 and the like, the user cluster generating section 145 performs clustering of users by using a predetermined method, on the basis of an item evaluation history held by the history holding section 132. The user cluster generating section 145 supplies to the user statistics calculating section 137 user cluster information related to user clusters generated as a result of the clustering.

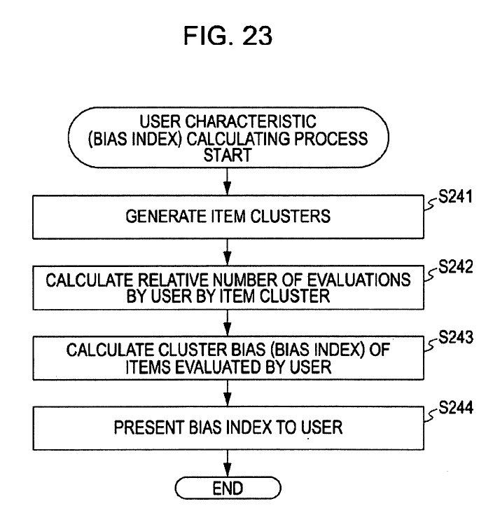

As will be described later with reference to FIG. 23 and the like, the item cluster generating section 146 performs clustering of items by using a predetermined method, on the basis of an item evaluation history held by the history holding section 132. The item cluster generating section 146 supplies to the user statistics calculating section 137 item cluster information related to item clusters generated as a result of the clustering.

The presentation rules holding section 147 acquires and holds presentation rules. The presentation rules prescribe the rules to be followed when presenting information related to items, which is inputted externally or via the input section 121 of the user interface section 111, to the user.

Next, referring to FIGS. 20 to 54, processing executed by the information processing system 101 will be described.

Like the information processing system 1, the information processing system 101 can execute the item evaluation acquiring process in FIG. 2, the item characteristic calculating process in FIG. 4, the similar item extracting process in FIG. 8, the user characteristic calculating process in FIG. 10, the similar user extracting process in FIG. 13, the item recommending process in FIG. 15, and the item recommending process in FIG. 16. The description of these processes is omitted to avoid repetition.

First of all, referring to FIGS. 20 to 42, a description will be given of a process in which the information processing system 101 obtains user and item characteristics.

First, referring to the flowchart in FIG. 20, a description will be given of a user characteristic (reputation orientation index) calculating process of calculating a reputation orientation index representing one kind of user statistics.

In step S201, as in the processing of step S21 in FIG. 21, the item statistics calculating section 133 acquires an item evaluation history. In the following, a description will be given specifically of a process in a case where the item evaluation history in FIG. 3 is acquired.

In step S202, the item statistics calculating section 133 calculates evaluation averages for individual items on the basis of the item evaluation history. Thus, the evaluation averages for individual items shown in the third row of FIG. 5 are calculated. The item statistics calculating section 133 supplies information indicating the calculated evaluation averages for individual items to the user statistics calculating section 137.

In step S203, the user statistics calculating section 137 calculates the average of the evaluation averages of items evaluated by a user. Specifically, the user statistics calculating section 137 selects one noted user, and calculates the average of the evaluation averages of items evaluated by the noted user. For example, if the user u1 is the noted user, the evaluation averages avg(Ri) of the items i2, i3, and i5 evaluated by the user u1 are 4.33, 4.4, and 2.67, respectively. Therefore, the average of the evaluation averages avg(Ri) of the items i2, i3, and i5 evaluated by the user u1 is 3.8(=(4.33+4.4+2.67)/3). The user statistics calculating section 137 sets the calculated average of the evaluation averages as the reputation orientation index of the noted user. The user statistics calculating section 137 repeats this calculation process until all the users become noted users.

The user statistics calculating section 137 supplies information indicating the reputation orientation indexes of individual users to the information presenting section 142. The information presenting section 142 adds the acquired reputation indexes to the information of individual users held by the user information holding section 144.

In step S204, the information presenting section 142 presents a reputation orientation index to a user. For example, when a command for presenting information related to the user A is inputted via the input section 121, the information presenting section 142 transmits the reputation orientation index of the user A to the display section 122 together with other pieces of information. The display section 122 displays the reputation orientation index of the user A together with the requested information of the user A.

At this time, the value of the reputation orientation index of the user A may be displayed as it is, or a value obtained by normalizing the reputation orientation index of the user A by using the average and variance of the reputation orientation indexes of all users may be displayed. Also, if, for example, the reputation orientation index of the user A exceeds a predetermined threshold, a message like “you have a high reputation orientation” may be displayed.

In this way, by making effective use of users' evaluations given to individual items, the reputation orientation indexes of individual users can be obtained for presentation.

In this regard, this reputation orientation index may be used when obtaining the similarity index between users in the similar user extracting process described above with reference to FIG. 13.

Next, referring to the flowchart in FIG. 21, a description will be given of a user characteristic (majority index) calculating process of calculating a majority index representing one kind of user statistics.

In step S221, the user cluster generating section 145 generates user clusters. First, the user cluster generating section 145 acquires an item evaluation history held by the history holding section 132. On the basis of the acquired item evaluation history, the user cluster generating section 145 generates, for example, matrices whose components are evaluation values given to individual items (hereinafter, referred to as user-item evaluation matrices) for individual users. By using the generated user-item evaluation matrices, the user cluster generating section 145 regards individual users as being placed in an item space, and performs clustering of users by using a predetermined method such as the k-means method within that item space.

The data used for clustering of users is not limited to specific data. For example, other kinds of data such as user preference information may be used as well. The term user preference information as used herein is expressed by vectors whose elements are the metadata of items that have been evaluated by the user as likes (items that have been given scores of 4 or 5 on a scale of 5, for example). In this case, clustering of users is performed in this content metadata space.

Also, instead of classifying individual users into one user cluster, for example, the soft clustering method may be used to obtain belonging weights indicating the degrees of belongingness of individual users to individual user clusters.

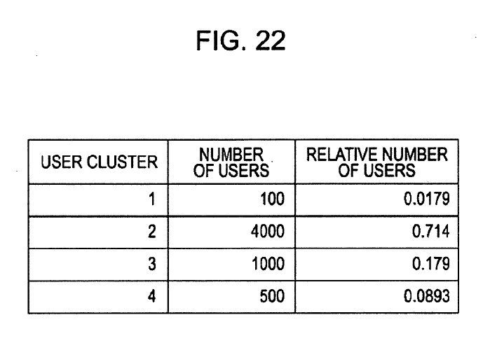

In the following, a description will be given of a case where 5600 users are classified into four user clusters, user clusters 1 to 4, as shown in FIG. 22. In the example of FIG. 22, 100 users belong to the user cluster 1, 4000 users belong to the user cluster 2, 1000 users belong to the user cluster 3, and 500 users belong to the user cluster 4.

The user cluster generating section 145 supplies user cluster information indicating users belonging to each individual user cluster, their number, and the like to the user statistics calculating section 137.

In step S222, the user statistics calculating section 137 calculates the relative number of users. Specifically, the user statistics calculating section 137 divides the number of users belonging to each individual user cluster by the total number of users to calculate the relative number of users in each individual user cluster. For example, in the example of FIG. 22, the relative number of users in the user cluster 1 is 0.0179(≅100/5600).

In step S223, the user statistics calculating section 137 sets the relative number of users in a user cluster to which each individual user belongs as the majority index of each individual user. Then, the user statistics calculating section 137 supplies information indicating the majority indexes of individual users to the information presenting section 142. The information presenting section 142 adds the acquired majority indexes to the information of individual users held by the user information holding section 144.

In step S224, the information presenting section presents a majority index to a user. For example, when a command for presenting information related to the user A is inputted via the input section 21, the information presenting section 142 transmits information indicating the majority index of the user A to the display section 122, together with the information of the user A. The display section 122 displays the majority index of the user A together with the requested information of the user A.

At this time, for example, the value of the majority index of the user A may be displayed as it is. Alternatively, a message like “you are the majority” may be displayed if the majority index of the user A is equal to or higher than a predetermined threshold B, or a message like “you are the minority” may be displayed if the majority index of the user A is equal to or lower than a predetermined threshold C that is lower than the threshold B.

In this way, by making effective use of users' evaluations given to individual items, the majority indexes of individual users can be obtained for presentation.

In this regard, this majority index may be used when obtaining the similarity index between users in the similar user extracting process described above with reference to FIG. 13.

Next, referring to the flowchart in FIG. 23, a description will be given of a user characteristic (bias index) calculating process of calculating a bias index representing one kind of user statistics.

In step S241, the item cluster generating section 146 generates item clusters. Specifically, the item cluster generating section 146 acquires an item evaluation history held by the history holding section 132. On the basis of the acquired item evaluation history, the item cluster generating section 146 generates, for example, matrices whose components are evaluation values given by individual users (hereinafter, referred to as item-user evaluation matrices) for individual items. By using the generated item-user evaluation matrices, the item cluster generating section 146 regards individual items as being placed in a user space, and performs clustering of items by using a predetermined method such as the k-means method within that user space. The item cluster generating section 146 supplies item cluster information indicating items belonging to each individual item cluster, the number of the items, and the like to the user statistics calculating section 137.

The data used for clustering of items is not limited to specific data. For example, metadata of items may be used as well. In the case of using metadata of items, each individual item is expressed by vectors whose elements are metadata, and clustering of items is performed in this metadata space.

Also, instead of classifying individual items into one item cluster, for example, the soft clustering method may be used to obtain belonging weights indicating the degrees of belongingness of individual items to individual item clusters.

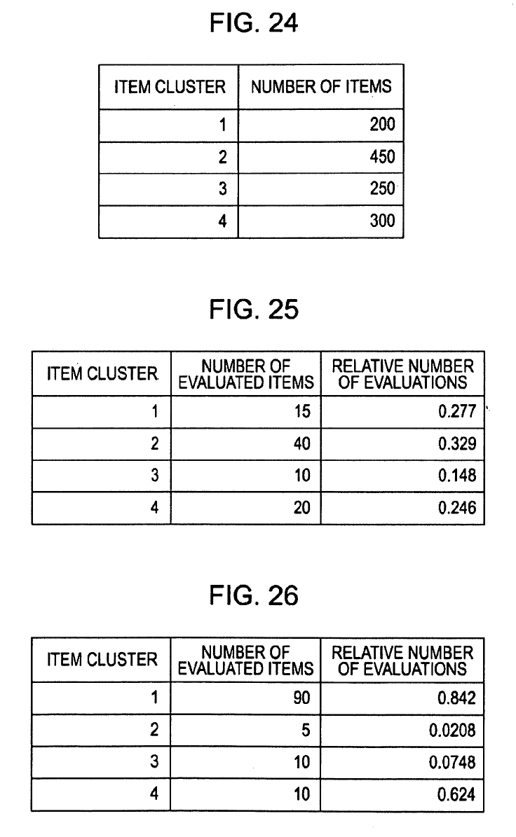

In the following, a description will be given of a case where 1200 items are classified into four item clusters, Item Clusters 1 to 4, as shown in FIG. 24. In the example of FIG. 24, 200 items belong to Item Cluster 1, 450 items belong to Item Cluster 2, 250 items belong to Item Cluster 3, and 300 items belong to Item Cluster 4.

In step S242, the user statistics calculating section 137 calculates the relative number of evaluations given by a user by item cluster. Specifically, first, the user statistics calculating section 137 acquires an item evaluation history held by the history holding section 132. The user statistics calculating section 137 selects one noted user, and on the basis of the acquired item evaluation history, tabulates the number of items evaluated by the noted user by item cluster. Then, on the basis of the tabulated result, the user statistics calculating section 137 calculates the relative number of evaluations indicating the ratio at which items evaluated by the noted user belong to each individual item cluster.

For example, a case is considered in which the result of tabulating the number of items evaluated by a user u10 by each of the four item clusters shown in FIG. 24 is as shown in FIG. 25. That is, of items evaluated by the user u10, 15 items belong to Item Cluster 1, 40 items belong to Item Cluster 1, 10 items belong to Item Cluster 1, and 20 items belong to Item Cluster 1.

First, the user statistics calculating section 137 obtains the ratio of items evaluated by the user u10 to items belonging to each item cluster, for each individual item cluster. For example, the ratio of items evaluated by the user u10 to items belonging to Item Cluster 1 is 0.075 (=15/200), the ratio of items evaluated by the user u10 to items belonging to Item Cluster 2 is 0.0889(=40/450), the ratio of items evaluated by the user u10 to items belonging to Item Cluster 3 is 0.04(=10/250), and the ratio of items evaluated by the user u10 to items belonging to Item Cluster 1 is 0.0667(=20/300).

Next, the user statistics calculating section 137 obtains the relative numbers of evaluations with respect to individual item clusters by performing normalization such that the sum of ratios obtained for individual item clusters becomes 1. For example, the relative number of evaluations by the user u10 with respect to Item Cluster 1 is obtained as 0.277(≅0.075/(0.075+0.0889+0.04+0.0667)) Likewise, the relative number of evaluations with respect to Item Cluster 2 is obtained as 0.329(≅0.0889/(0.075+0.0889+0.04+0.0667)), the relative number of evaluations with respect to Item Cluster 3 is obtained as 0.148(≅0.04/(0.075+0.0889+0.04+0.0667)), and the relative number of evaluations with respect to Item Cluster 4 is obtained as 0.246(≅0.0667/(0.075+0.0889+0.04+0.0667)).

That is, this relative number of evaluations indicates the ratio at which items evaluated by the user u10 belong to each individual item cluster, while removing the influence of a bias in the numbers of items belonging to individual item clusters.

FIG. 26 shows an example of the distribution of the numbers of items evaluated by a user u11 and relative numbers of evaluations. For example, in FIG. 26, of items evaluated by the user u11, 90 items belong to Item Cluster 1, and the relative number of evaluations with respect to Item Cluster 1 is 0.842.

In step S243, the user statistics calculating section 137 calculates a cluster bias (bias index) of items evaluated by a user. For example, the user statistics calculating section 137 calculates the variance of the relative numbers of evaluations by a noted user as a bias index. For example, the variance of the relative numbers of evaluations by the user u10 shown in FIG. 10, that is, the bias index is 0.00434, and the variance of the relative numbers of evaluations by the user u11 shown in FIG. 11, that is, the bias index is 0.117.

This bias index indicates the degree of a bias in the item cluster-specific distribution of the numbers of items evaluated by the user. For example, if the item is video content, a large bias index indicates that the user in question is very particular about watching or listening to those items which have specific features. On the other hand, a small bias index indicates that the user in question watches all items evenly, and hence does not have very strong likes and dislikes.

In addition, the bias index may be calculated also by, for example, using a function that monotonically decreases with respect to the entropy of the relative number of evaluations.

The user statistics calculating section 137 repeats the processing of step S242 and S243 until all the users become noted users, thereby calculating bias indexes of individual users. Then, the user statistics calculating section 137 supplies information indicating the bias indexes of individual users to the information presenting section 142. The information presenting section 142 adds the acquired bias indexes to the information of individual users held by the user information holding section 144.

In step S244, the information presenting section 142 presents a bias index to a user. For example, when a command for presenting information related to the user A is inputted via the input section 121, the information presenting section 142 transmits the bias index of the user A to the display section 122 together with other pieces of information. The display section 122 displays the bias. index of the user A together with the requested information of the user A.

At this time, for example, the value of the bias index of the user A may be displayed as it is. Alternatively, a message like “you are a very particular person” may be displayed if the bias index of the user A is equal to or higher than a predetermined threshold B, or a message like “you have a wide range of hobbies” may be displayed if the bias index of the user A is lower than a predetermined threshold C that is lower than the threshold B.

In this way, by making effective use of users' evaluations given to individual items, the bias index of each individual user can be obtained for presentation.

In this regard, this bias index may be used when obtaining the similarity index between users in the similar user extracting process described above with reference to FIG. 13.

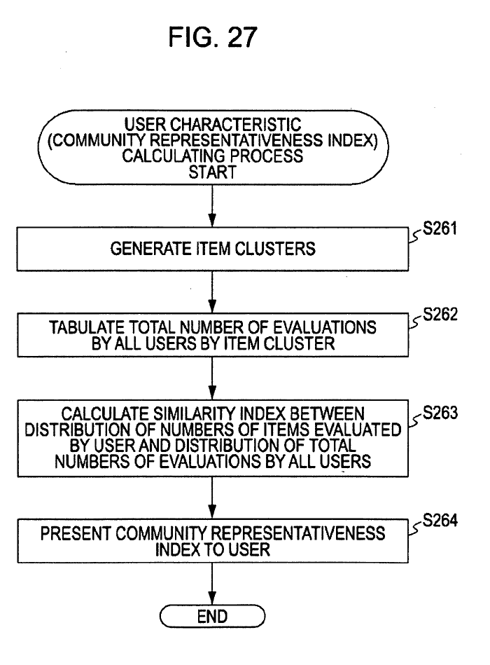

Next, referring to the flowchart in FIG. 27, a description will be given of a user characteristic (community representativeness index) calculating process of calculating a community representativeness index representing one kind of user statistics.

In step S261, as in the processing of step S241 in FIG. 23 described above, the item cluster generating section 146 generates item clusters. The item cluster generating section 146 supplies item cluster information indicating the generated item clusters to the user statistics calculating section 137. In the following, a description will be given of a case where, as shown in FIG. 24 described above, 1200 items are classified into four item clusters, Item Clusters 1 to 4.

In step S262, the user statistics calculating section 137 tabulates the total number of evaluations by all users by item cluster. Specifically, first, the user statistics calculating section 137 acquires an item evaluation history held by the history holding section 132. On the basis of the acquired item evaluation history, the user statistics calculating section 137 tabulates the total number of evaluations on all items by all users by item cluster. This tabulated result gives an indication of in which item cluster users have interest.

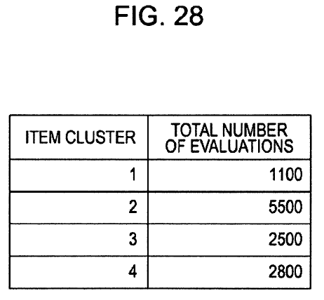

In the following, a description will be given of a case where, as shown in FIG. 28, the total number of evaluations for Item Cluster 1 is 1100, the total number of evaluations for Item Cluster 2 is 5500, the total number of evaluations for Item Cluster 3 is 2500, and the total number of evaluations for Item Cluster 4 is 2800.

In step S263, the user statistics calculating section 137 calculates the similarity index between the distribution of the numbers of items evaluated by a user and the distribution of the total numbers of evaluations by all users. For example, the user statistics calculating section 137 selects one noted user, and tabulates the number of items evaluated by the noted user by item cluster. Then, the user statistics calculating section 137 calculates the distance (for example, the cosine similarity index, the Euclidean distance, or the like) between vectors whose elements are the numbers of items evaluated by the noted user broken down by item clusters, and vectors whose elements are the total numbers of evaluations by all users broken down by item clusters, as the similarity index between the distribution of the numbers of items evaluated by the user and the distribution of the total numbers of evaluations by all users on the item clusters. That is, the user statistics calculating section 137 calculates the similarity index between the item cluster-specific distribution of the numbers of items evaluated by the noted user, and the item cluster-specific distribution of the numbers of evaluations by the entire community to which the noted user belongs.

For example, if the cosine similarity index is used as a similarity index, the distribution of the numbers of evaluations by the user u10 described above (FIG. 25) and the distribution of the total numbers of evaluations by all users (FIG. 28) is 0.291.

If this similarity index is high, this means that the evaluation tendency of the entire community to which the noted user belongs is similar to the evaluation tendency of the noted user. Hence, it can be said that the noted user is a representative user of the community. Conversely, if this similarity index is low, it can be said that the noted user has an evaluation tendency different from that of the entire community. Therefore, it can be said that the user u10 is more representative of the community to which the user u10 and the user u11 belong, than the user u11. Hereinafter, this similarity index will be referred to as community representativeness index.

When obtaining the item cluster-specific distribution of the numbers of evaluations by the entire community, the total number of evaluations by all users may not necessarily be used. For example, a predetermined number of users may be extracted at random from the community, and the total number of evaluations by the extracted users may be used.

The user statistics calculating section 137 repeats the process of calculating the community representativeness index of the noted user until all the users become noted users, thereby calculating community representativeness indexes of individual users. Then, the user statistics calculating section 137 supplies information indicating the community representativeness indexes of individual users to the information presenting section 142. The information presenting section 142 adds the acquired community representativeness indexes to the information of individual users held by the user information holding section 144.

In step S264, the information presenting section 142 presents a community representativeness index to a user. For example, when a command for presenting information related to the user A is inputted via the input section 121, the information presenting section 142 transmits the community representativeness index of the user A to the display section 122 together with other pieces of information. The display section 122 displays the community representativeness index of the user A together with the requested information of the user A.

At this time, for example, the value of the community representativeness index of the user A may be displayed as it is. Alternatively, a message like “you are a representative user of this community” may be displayed if the community representativeness index of the user A is equal to or higher than a predetermined threshold B, or a message like “you are a distinct being in the community” may be displayed if the community representativeness index of the user A is lower than a predetermined threshold C that is lower than the threshold B.

In this way, by making effective use of users' evaluations given to individual items, the community representativeness index of each individual user can be obtained for presentation.

In this regard, this community representativeness index may be used when obtaining the similarity index between users in the similar user extracting process described above with reference to FIG. 13.

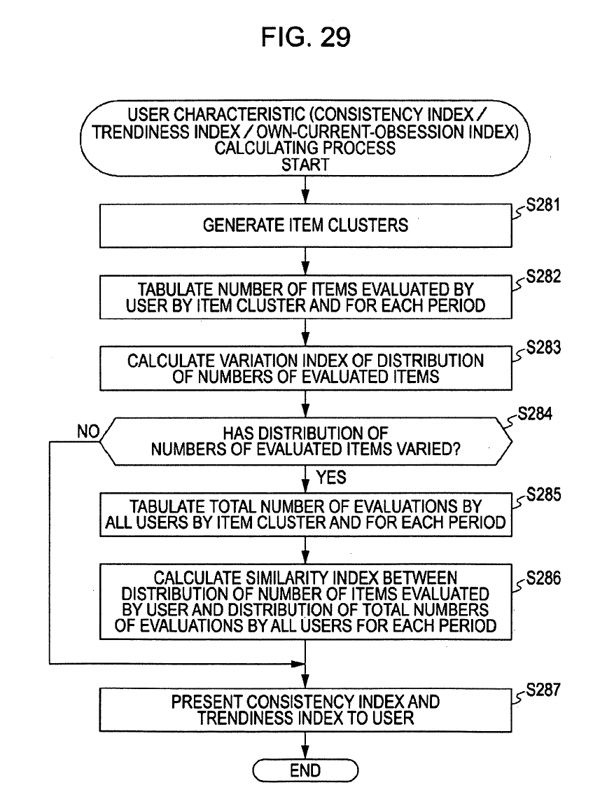

Next, referring to the flowchart in FIG. 29, a description will be given of a user characteristic (consistency index/trendiness index/my-own-current-obsession index) calculating process of calculating a consistency index, a trendiness index, and a my-own-current-obsession index each representing one kind of user statistics.

In step S281, as in the processing of step S241 in FIG. 23 described above, the item cluster generating section 146 generates item clusters. First, the item cluster generating section 146 supplies item cluster information indicating the generated item clusters to the user statistics calculating section 137. In the following, a description will be given of a case where, as shown in FIG. 24 described above, 1200 items are classified into four item clusters, Item Clusters 1 to 4.

In step S282, the user statistics calculating section 137 tabulates the number of items evaluated by a user, by item cluster and for each period. Specifically, first, the user statistics calculating section 137 acquires an item evaluation history held by the history holding section 132. The user statistics calculating section 137 selects one noted user, and on the basis of the acquired item evaluation history, tabulates the number of items evaluated by the noted user, by item cluster and for each predetermined period.

The term period as used in this context refers to a period of time that is determined on the basis of an absolute reference (hereinafter, referred to as absolute period) such as January, February, or March, irrespective of the release timing of an item or the timing when a user starts using a service. Also, the length of such an absolute period may be set to the same length that is common to all users (for example, one month), or may be set for each individual user to a period until a predetermined number of items are evaluated. In the latter case, the length may vary from period to period.

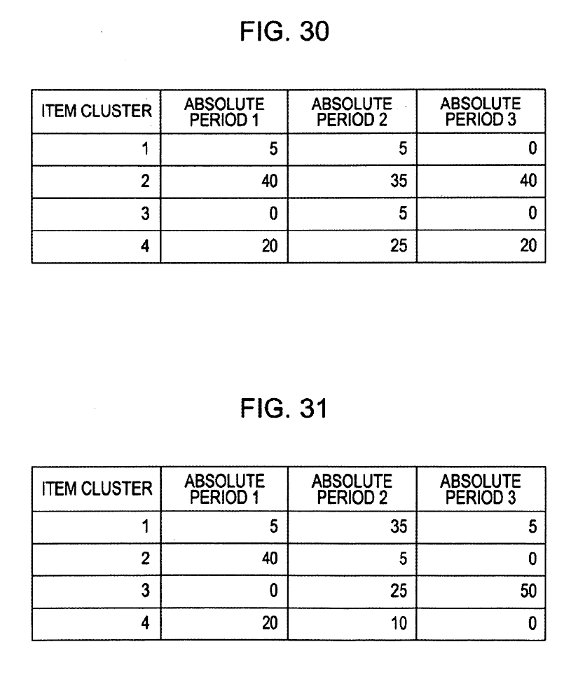

FIGS. 30 to 32 show the distribution of the numbers of items evaluated by users u20 to u22 in Absolute Periods 1 to 3, broken down by cluster. For example, in FIG. 30, of items evaluated by the user u20, the number of items belonging to Item Cluster 1 is 5 in Absolute Period 1, is 5 in Absolute Period 2, and is 0 in Absolute Period 3. Also, for example, in FIG. 31, of items evaluated by the user u21, the number of items belonging to Item Cluster 2 is 40 in Absolute Period 1, is 5 in Absolute Period 2, and is 0 in Absolute Period 3. Further, for example, in FIG. 32, of items evaluated by the user u22, the number of items belonging to Item Cluster 3 is 30 in Absolute Period 1, is 20 in Absolute Period 2, and is 10 in Absolute Period 3.

In step S283, the user statistics calculating section 137 calculates the variation index of the distribution of the numbers of evaluated items. That is, the user statistics calculating section 137 calculates the degree of time-series variation in the distribution of the numbers of items evaluated by the noted user broken down by item cluster. For example, with the distribution of the numbers of evaluated items in each individual period expressed as vectors in the item cluster space, the user statistics calculating section 137 calculates the cosine similarity index between individual vectors as the variation index of the distribution of the numbers of evaluated items.

For example, in the case of the user u20, the cosine similarity indexes between Absolute Period 1 and Absolute Period 2, between Absolute Period 2 and Absolute Period 3, and between Absolute Period 1 and Absolute Period 3 are 0.981. 0.975, and 0.994, respectively. Also, in the case of the user u21, the cosine similarity indexes between Absolute Period 1 and Absolute Period 2, between Absolute Period 2 and Absolute Period 3, and between Absolute Period 1 and Absolute Period 3 are 0.288. 0.638, and 0.0111, respectively. Further, in the case of the user u22, the cosine similarity indexes between Absolute Period 1 and Absolute Period 2, between Absolute Period 2 and Absolute Period 3, and between Absolute Period 1 and Absolute Period 3 are 0.464. 0.359, and 0.0820, respectively.

The higher the cosine similarity index, the smaller the time-series variation in the distribution of the numbers of items evaluated by a noted user broken down by item cluster, which indicates that the noted user tends to evaluate items in consistently the same way in individual periods. Hereinafter, this cosine similarity index will be referred to as consistency index. That is, the consistency index indicates the time-series stability index of the distribution of the numbers of items evaluated by the noted user broken down by item cluster. A measure of similarity other than the cosine similarity index may also be used as the consistency index.

In step S284, the user statistics calculating section 137 determines whether or not the distribution of the numbers of evaluated items has varied. For example, the user statistics calculating section 137 determines the distribution of the numbers of evaluated items to have varied if the consistency index of the noted user is equal to or lower than a predetermined threshold (for example, 0.5) in all periods, and otherwise determines the distribution of the numbers of evaluated items as being stable. Alternatively, for example, the user statistics calculating section 137 determines the distribution of the numbers of evaluated items to be stable if the consistency index of the noted user is equal to or higher than a predetermined threshold (for example, 0.9) in all periods, and otherwise determines the distribution of the numbers of evaluated items to have varied. For example, in the case of the users u20 to u22, the distribution of the numbers of evaluated items is determined to be stable for the user u20, and the distribution of the numbers of evaluated items is determined to have varied for each of the users u21 and u22.

The threshold used for the above determination may be set to a suitable value in advance, or may be made to vary for each period on the basis of the distribution of the total numbers of evaluations by all users, for example.

If the user statistics calculating section 137 determines that the distribution of the numbers of items evaluated by the noted user has varied, the process proceeds to step S285.

In step S285, the user statistics calculating section 137 tabulates the total number of evaluations by all users, by item cluster and for each period. Specifically, on the basis of an item evaluation history, the user statistics calculating section 137 tabulates the total number of evaluations by all users, by item cluster and for each predetermined period. This tabulated result gives an indication of in which item cluster users have interest, for each period.

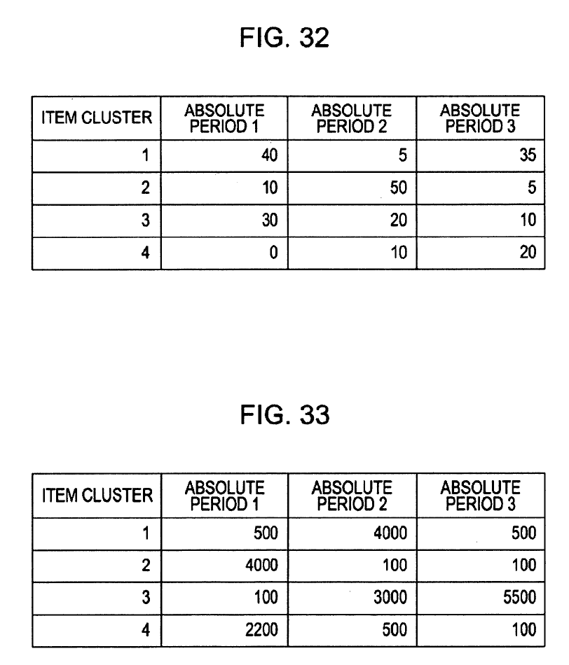

FIG. 33 shows the distribution of the total numbers of evaluations by all users in Absolute Periods 1 to 3, broken down by item cluster. For example, in FIG. 33, the total number of evaluations on items belonging to Item Cluster 1 is 500 in Absolute Period 1, is 4000 in Absolute Period 2, and is 500 in Absolute Period 3.

In step S286, the user statistics calculating section 137 calculates the similarity index between the distribution of the numbers of items evaluated by a user and the distribution of the total numbers of evaluations by all users, for each period. That is, the user statistics calculating section 137 calculates the community representativeness index of a noted user for each period.

For example, if the community representativeness index is calculated by using the cosine similarity index, the community representativeness index of the user u21 is 0.999 in Absolute Period 1, is 0.987 in Absolute Period 2, and is 1.000 in Absolute Period 3. On the other hand, the community representativeness index of the user u22 is 0.269 in Absolute Period 1, is 0.326 in Absolute Period 2, and is 0.325 in Absolute Period 3.

If this community representativeness index is high on average, it can be said that the noted user is a user having a tendency toward trends who changes his/her behaviors (for example, which item to watch or listen to) in keeping with the trends of the world (community to which the noted user belongs). Conversely, if this community representativeness index is low on average, it can be said that the noted user is a user having a my-own-current-obsession type tendency who does not care about the behaviors of users other than himself/herself and for whom the kind of item in which he/she is interested changes from time to time.

In this regard, if it is set in advance such that a user with an average value of community representativeness index equal to or higher than 0.9 is a trendy type user, and a user with an average value equal to or lower than 0.4 is a my-own-current-obsession type user, the user u21 is classified as a trendy type user, and the user u22 is classified as a my-own-current-obsession type user. Hereinafter, the time-series average of the community representativeness index will be referred to as trendiness index, and the inverse of the trendiness index will be referred to as my-own-current-obsession index.

Thereafter, the process proceeds to step S287.

On the other hand, if it is determined in step S284 that the distribution of the numbers of items evaluated by the noted user is stable, the processing of steps S285 and S286 is skipped, and the process proceeds to step S287.

The user statistics calculating section 137 repeats the processing of steps S282 to S286 until all the users become noted users, thereby calculating the consistency indexes and trendiness indexes of individual users. It should be noted, however, that it is not necessary to perform the processing of step S285 every time unless the tabulation period varies among users. Then, the user statistics calculating section 137 supplies information indicating the consistency indexes and trendiness indexes of individual users to the information presenting section 142. The information presenting section 142 adds the acquired consistency indexes and trendiness indexes to the information of individual users held by the user information holding section 144.

In step S287, the information presenting section 142 presents a consistency index and a trendiness index to a user. For example, when a command for presenting information related to the user A is inputted via the input section 121, the information presenting section 142 transmits the consistency index and trendiness index of the user A to the display section 122 together with other pieces of information. The display section 122 displays the consistency index and trendiness index (or my-own-current obsession index) of the user A together with the requested information of the user A.

At this time, for example, the values of the consistency index and trendiness index of the user A may be displayed as they are, or a characteristic of the user A (consistent type, trendy type, or my-own-current-obsession type) as determined from the consistency index and the trendiness index may be displayed.

In this way, by making effective use of users' evaluations given to individual items, the consistency indexes and trendiness indexes (or my-own-current-obsession indexes) of individual users can be obtained for presentation.

In this regard, these consistency index and trendiness index may be used when obtaining the similarity index between users in the similar user extracting process described above with reference to FIG. 13.

Next, referring to the flowchart in FIG. 34, a description will be given of an item characteristic (instantaneousness index/word-of-mouth index/standardness index/regular-fan index) calculating process of calculating an instantaneousness index, a word-of-mouth index, a standardness index, and a regular-fan index each representing one kind of item statistics.

In step S301, the item statistics calculating section 133 tabulates the time-series variation in the number of evaluations on all items. Specifically, the item statistics calculating section 133 acquires an item evaluation history held by the history holding section 132. On the basis of the item evaluation history, the item statistics calculating section 133 tabulates the numbers of evaluations given to individual items by individual users for each period.

The term period as used in this context refers to a relative period of time (hereinafter, referred to as relative period) with reference to the point in time when each individual item becomes available, such as the first week, second week, or third week after an item becomes available. Also, the length of the relative period is set to a suitable value in accordance with the kind of item. For example, if the item is music content, since music content is sold over somewhat long period of time, the length of one period is set to, for example, one month. On the other hand, if the item is a news article on a website, since a news article on a website has a high immediacy, the length of one period is set to, for example, one day.

Also, the item statistics calculating section 133 tabulates the total number of evaluations on all items by all users for each relative period.

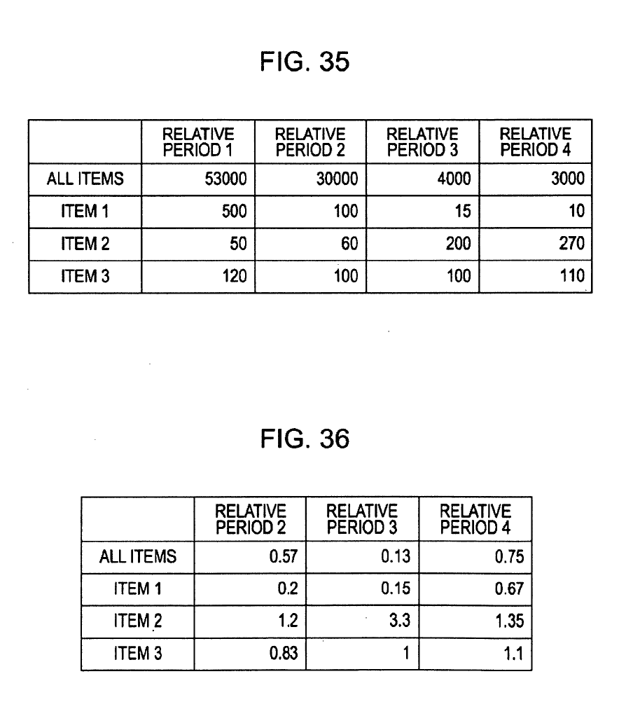

FIG. 35 shows an example of the result of tabulating the numbers of evaluations on items in Relative Periods 1 to 4. For example, in FIG. 35, the total number of evaluations on all items is 53000 in Relative Period 1, is 30000 in Relative Period 2, is 4000 in Relative Period 3, and is 3000 in Relative Period 4. Also, the number of evaluations on Item 1 is 500 in Relative Period 1, is 100 in Relative Period 2, is 15 in Relative Period 3, and is 10 in Relative Period 4.

In step S302, the item statistics calculating section 133 calculates the relative number of evaluations in each individual period with respect to the immediately previous period. Specifically, for each one of relative periods from the second relative period onwards, the item statistics calculating section 133 calculates the ratio of the number of evaluations in that relative period to the number of evaluations in the immediately previous period, as the number of evaluations relative to previous period.

For example, FIG. 36 shows the numbers of evaluations relative to previous period calculated with respect to the tabulated result in FIG. 35. For example, in FIG. 36, the number of evaluations relative to previous period for all items in Relative Period 2 with respect to Relative Period 1 (hereinafter, simply referred to as the number of evaluations relative to previous period in Relative Period 2) is 0.57(=30000/53000), the number of evaluations relative to previous period in Relative Period 3 with respect to Relative Period 2 (hereinafter, simply referred to as the number of evaluations relative to previous period in Relative Period 3) is 0.13(=4000/30000), and the number of evaluations relative to previous period in Relative Period 4 with respect to Relative Period 3 (hereinafter, simply referred to as the number of evaluations relative to previous period in Relative Period 4) is 0.75(=3000/4000). Also, the number of evaluations relative to previous period for Item 1 in Relative Period 2 is 0.2(=100/500), the number of evaluations relative to previous period in Relative Period 3 is 0.15(=15/100), and the number of evaluations relative to previous period in Relative Period 4 is 0.67(=10/15).

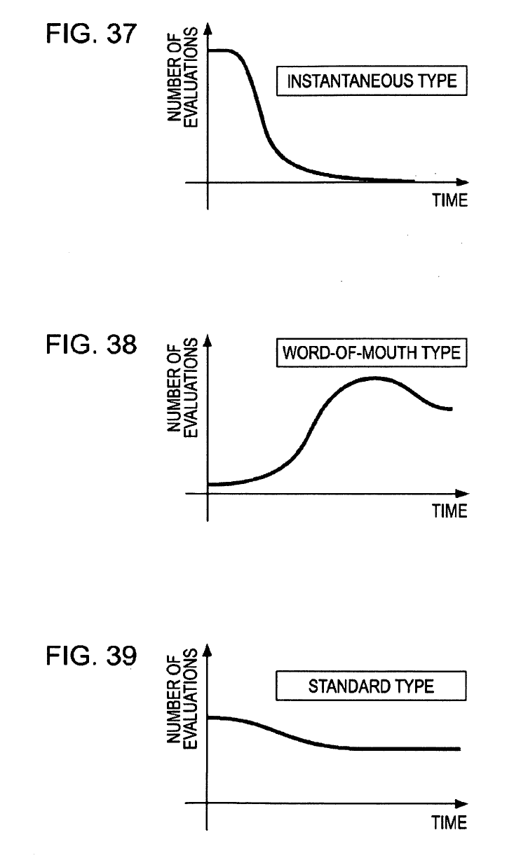

In step S303, the item statistics calculating section 133 calculates an instantaneousness index, a word-of-mouth index, a standardness index, and a regular-fan index. Specifically, for example, as shown in FIG. 37, an item that is evaluated most frequently at the timing when the item becomes available, and for which the number of evaluations then soon decreases, can be said to be high on the instantaneousness index. For example, if the item is video content, an item that pops up on the market, is watched/listened to most frequently at first, and then soon ceases to be watched/listened to is an item with a high instantaneousness index.

The item statistics calculating section 133 determines this instantaneousness index of each individual item on the basis of how fast the number of evaluations on that item decreases relative to the average tendency for all items. For example, in the example of FIG. 36, the average of the numbers of evaluations relative to previous period for all items in Relative Period 2 and Relative Period 3 is 0.35, whereas the average of the numbers of evaluations relative to previous period for Item 1 in Relative Period 2 and Relative Period 3 is 0.18. Therefore, it can be said that the number of evaluations on Item 1 decreases at a speed that is about twice the average speed for all items.

In this case, the instantaneousness index of Item 1 is obtained as 1.9(=0.35/0.18), which is a value obtained by dividing the average of the numbers of evaluations relative to previous period for Item 1 in Relative Period 2 and Relative Period 3, by the average of the numbers of evaluations relative to previous period for all items in Relative Period 2 and Relative Period 3. That is, the instantaneousness index indicates the relative speed at which the number of evaluations on each individual item decreases with respect to the average speed at which the number of evaluations decreases from when an item becomes available.

As shown in FIG. 38, an item that is not evaluated much at first but gradually comes to be evaluated frequently is a type of item that spreads by word of mouth. Such an item can be said to have a high word-of-mouth index. For example, in a case where an item is video content, if the number of times the item is watched/listened to or the number of sales of the item grows slowly but steadily, the item can be said to have a high word-of-mouth index. For example, in the example of FIG. 36, the number of evaluations relative to previous period for Item 2 is 1 or more in all of Relative Periods 2 to 4, and is large with a value of 3.3 in Relative Period 3. Therefore, it is presumed that the popularity of Item 2 gradually but steadily grew after its release, and then exploded in Relative Period 3.

For example, a value obtained by multiplying all the numbers of evaluations relative to previous period from Relative Period 2 to Relative Period 4 together is set as the word-of-mouth index. In this case, the word-of-mouth index of Item 2 is 5.35(=1.2×3.3×1.35). Alternatively, for example, only in a case where the number of evaluations in the last relative period within the tabulation period is larger than the number of evaluations in the first relative period, the word-of-mouth index may be set as a value obtained by multiplying together the numbers of evaluations relative to previous period from a relative period following a relative period in which the number of evaluations relative to previous period was 1 or less last time, to a relative period in which the number of evaluations relative to previous period was 1 or more last time. Thus, the word-of-mouth index indicates the length of the period during which the number of evaluations on each individual item increases, and the degree of increase in the number of evaluations.

Further, for example, as shown in FIG. 39, an item that is evaluated in a stable manner irrespective of timing can be said to be item with a high standardness index. For example, in a case where an item is video content, if the item is watched/listened to or sold in a stable manner over a long period of time, the item has a high standardness index. That is, it can be said that the standardness index becomes higher as the average m of the numbers of evaluations relative to previous period becomes closer to 1, its variance σ² becomes smaller, and the period of time p for which these conditions are met becomes longer. Therefore, for example, the standardness index can be defined by p×N(m;1, σ²). The function N( ) is a probability density function of normal distribution which is expressed by Equation (8) below.

$$N ( x ; μ , {σ}^{2} ) = \frac{1}{\sqrt{2 πσ}} exp ( - \frac{{( x - μ )}^{2}}{2 {σ}^{2}} ) \qquad ( 8 )$$

The period p is set as a period during which the number of evaluations relative to previous period continuously falls with a predetermined range (for example, 0.8 to 1.2), and during which the number of evaluations in each corresponding relative period exceeds a predetermined threshold at or above which an item is recognized as a standard item.

In the case of Item 3 in FIG. 36, the average m of the numbers of evaluations relative to previous period in Relative Periods 2 to 4 is equal to 0.98, and its variance σ² is equal to 0.012, so the standardness index is 10.7(=3×(1/(2π×0.012)^{0.5}×exp(−(0.98−1)²/(2×0.012)))). Thus, the standardness index indicates the time-series stability index of the number of evaluations on each individual item.

Also, of items with high standardness indexes, an item that is evaluated regularly by a particularly narrow range of users is presumed to be an item that has regular fans.

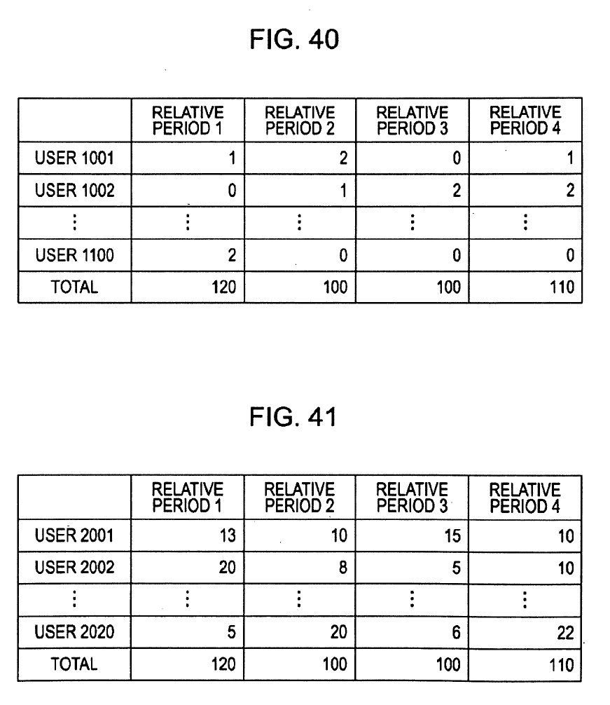

FIG. 40 shows the transition of the number of evaluations on Item 3 in Relative Periods 1 to 4, and FIG. 41 shows the transition of the number of evaluations on Item 4 in Relative Periods 1 to 4. The total of the numbers of evaluations in individual relative periods is the same between Item 3 and Item 4. It should be noted, however, that in Relative Periods 1 to 4, Item 3 is evaluated by a total of 100 users from Users 1001 to 1100, whereas Item 4 is evaluated by a total of 20 users from Users 2001 to 2020. In this case, the regular-fan index is defined as the average number of evaluations per one user within a predetermined period. Therefore, the regular-fan index of Item 3 in Relative Period 1 is 1.2(=120/100), and the regular-fan index of Item 4 is 6(=120/20). For example, in a case where an item is video content, if the item is watched/listened to by or sells to specific people for a long period of time, the item has a high regular-fan index.

The item statistics calculating section 133 repeats a process of selecting one noted item and obtaining the instantaneousness index, word-of-mouth index, standardness index, and regular-fan index of the noted item, until all the items become noted items, thereby obtaining the instantaneousness indexes, word-of-mouth indexes, standardness indexes, and regular-fan indexes of individual items. The item statistics calculating section 133 supplies information indicating the obtained instantaneousness indexes, word-of-mouth indexes, standardness indexes, and regular-fan indexes of individual items to the information presenting section 142. The information presenting section adds the obtained instantaneousness indexes, word-of-mouth indexes, standardness indexes, and regular-fan indexes of individual items to the information of individual items held by the item information holding section 143.

At this time, the obtained instantaneousness indexes, word-of-mouth indexes, standardness indexes, and regular-fan indexes of individual items may be supplied from the item statistics calculating section 133 to the item type determining section 134 to determine the item types of individual items. For example, the item types of items whose instantaneousness indexes, word-of-mouth index, standardness indexes, and regular-fan indexes exceed corresponding predetermined thresholds are determined as the instantaneous type, word-of-mouth type, standard type, and regular-fan type, respectively.

In step S304, the information presenting section 142 presents an instantaneousness index, a word-of-mouth index, a standardness index, and a regular-fan index to a user. For example, when presenting information on an item to a user as in the processing of step S1 of FIG. 4, the information presenting section 142 also transmits information indicating the instantaneousness index, word-of-mouth index, standardness index, and regular-fan index of the item to the display section 122. The display section 122 displays the instantaneousness index, word-of-mouth index, standardness index, and regular-fan index of the item, together with information related to the item requested by the user.

At this time, the values of the instantaneousness index, word-of-mouth index, standardness index, and regular-fan index of the item may be displayed as they are, or an indication of items types as determined from the instantaneousness index, the word-of-mouth index, the standardness index, and the regular-fan index, that is, the instantaneous type, the word-of-mouth type, the standard type, and the regular-fan type may be displayed.

In this way, by making effective use of users' evaluations given to individual items, the instantaneousness indexes, word-of-mouth indexes, standardness indexes, and regular-fan indexes of individual items can be obtained for presentation to a user. Thus, the user can accurately learn the tendency of evaluations given to individual items.

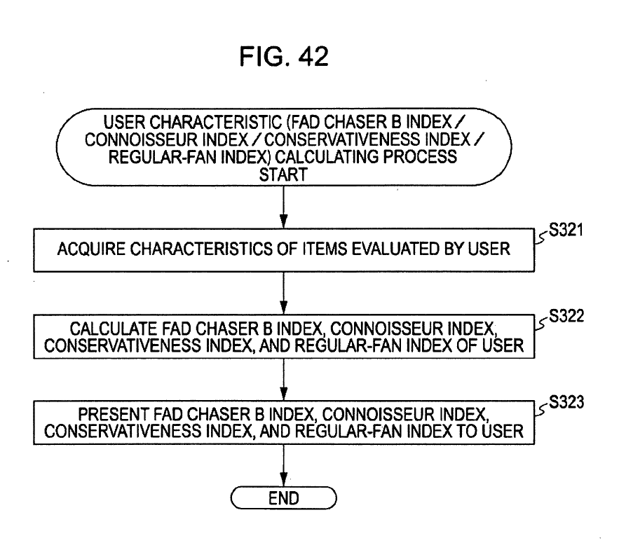

Next, referring to the flowchart in FIG. 42, a description will be given of a user characteristic (fad chaser B index/connoisseur index/conservativeness index/regular-fan index) calculating process of calculating a fad chaser B index, a connoisseur index, a conservativeness index, and a regular-fan index each representing one kind of user statistics.

In step S321, the user statistics calculating section 137 acquires characteristics of items evaluated by a user. Specifically, the user statistics calculating section 137 selects one noted user, and acquires an item evaluation history related to the noted user from the history holding section 132. Also, the user statistics calculating section 137 acquires information indicating characteristic (instantaneousness index, word-of-mouth index, standardness index, and regular-fan index) of items evaluated by the noted user from the item information holding section 143 via the information presenting section 142.

In step S322, the user statistics calculating section 137 calculates the fad chaser B index, connoisseur index, conservativeness index, and regular-fan index of the user. For example, if the noted user has frequently evaluated items with a specific characteristic, a new characteristic of the noted user can be thus defined. In this case, whether or not items with a specific characteristic have been frequently evaluated is determined on the basis of the ratio of the items with the specific characteristic to the total number of items evaluated by the noted user, the ratio of the total number of evaluations on the items with the specific characteristic to the total number of evaluations by the noted user, or the like. In this case, the total number of evaluations is defined such that if the noted user evaluates the same item a plurality of times, each time the item is evaluated, this is counted as one evaluation.

For example, generally, the recognition of an item with a high instantaneousness index is often enhanced in advance by an advertisement or the like. Therefore, if a noted user evaluates an item with a high instantaneousness index immediately after the item becomes available, it can be said that noted user is a fad chaser. In the following description, to differentiate between the fad chaser index described above with reference to FIG. 10 and the like which is based on the majorness index of an item, and the fad chaser index based on the instantaneousness index of an item which will be described below, the former is referred to as fad chaser A index, and the latter is referred to as fad chaser B index.

For example, supposing that of items evaluated by a noted user, 40 items are instantaneous type items with instantaneousness indexes equal to or higher than a predetermined threshold, if 80 items are evaluated within Relative Period 1, 0.4×0.8=0.32 is defined as the fad chaser B index of the noted user. That is, the fad chaser B index is based on the ratio of instantaneous type items evaluated within a predetermined period after the items become available, to items evaluated by the noted user. At this time, the period for which the fad chaser B index is evaluated may not necessarily coincide with the relative period used when evaluating the instantaneousness index of an item. For example, the fad chaser B index may be evaluated for a shorter, more finely divided period. Also, for example, to reduce the influence of the proportion of instantaneous type items to items evaluated by the noted user, (0.4)^{0.5}×0.8=0.51 may be defined as the fad chaser B index.

Conversely, it follows that a user with a low fad chaser B index evaluates an instantaneous type items after some time elapses, and as such this user can be said to be a hit follower type user who follows hits.

Also, for example, if a noted user evaluates an item with a high word-of-mouth index immediately after the item becomes available, the noted user can be said to be a connoisseur user who predicts trends.

For example, supposing that of items evaluated by a noted user, 40 items are word-of-mouth type items with word-of-mouth indexes equal to or higher than a predetermined threshold, if 80 items are evaluated within Relative Period 1, 0.4×0.8=0.32 can be defined as the connoisseur index of the noted user. That is, the connoisseur index is based on the ratio of word-of-mouth type items evaluated within a predetermined period after the items become available, to items evaluated by the noted user. At this time, it can be said that the earlier the time when the noted user evaluates a given item with respect to the relative period in which the total number of evaluations on that item becomes the highest, the higher the connoisseur level of the noted user. Also, the period for which the connoisseur index is evaluated may not necessarily coincide with the relative period used when evaluating the word-of-mouth index of an item. For example, the connoisseur index may be evaluated for a shorter, more finely divided period. Also, for example, to reduce the influence of the proportion of items with high word-of-mouth indexes to items evaluated by the noted user, (0.4)^{0.5}×0.8=0.51 may be defined as the connoisseur index.

Conversely, it follows that a user with a low connoisseur index evaluates word-of-mouth type items after some time elapses, and as such this user can be said to be a word-of-mouth follower type user who follows hits.

Further, for example, if a noted user evaluates only mostly items with high standardness indexes, it can be said that the noted user is conservative. For example, the ratio of standard type items with standardness indexes equal to or higher than a predetermined threshold, to items evaluated by the noted user can be defined as a conservativeness index as it is.

Further, for example, if a noted user evaluates only mostly items with higher regular-fan indexes, it can be said that the noted user is a regular fan of specific items. For example, the ratio of the number of regular-fan type items with regular-fall indexes equal to or higher than a predetermined threshold, to the items evaluated by the noted user can be defined as a regular-fan index as it is.

The user statistics calculating section 137 repeats a process of selecting one noted user and obtaining the fad chaser B index, connoisseur index, conservativeness index, and regular-fan index of the noted user, until all the users become noted users, thereby obtaining the fad chaser B indexes, connoisseur indexes, conservativeness indexes, and regular-fan indexes of individual users. The user statistics calculating section 137 supplies information indicating the obtained fad chaser B indexes, connoisseur indexes, conservativeness indexes, and regular-fan indexes of individual users to the information presenting section 142. The information presenting section adds the obtained fad chaser B indexes, connoisseur indexes, conservativeness indexes, and regular-fan indexes of individual users to the information of individual users held by the user information holding section 144.

In step S323, the information presenting section 142 presents a fad chaser B index, a connoisseur index, a conservativeness index, and a regular-fan index to a user. For example, when a command for presenting information related to the user A is inputted via the input section 121, the information presenting section 142 adds the fad chaser B index, connoisseur index, conservativeness index, and regular-fan index of the user A to information of the user A, and transmits the information to the display section 122. The display section 122 displays the fad chaser B index, connoisseur index, conservativeness index, and regular-fan index of the user A, together with information related to the user A requested by the user.

In this way, on the basis of a characteristic which many of items evaluated by a noted user has among item characteristics represented by item statistics (the instantaneousness index, word-of-mouth index, standardness index, and regular-fan index), the user statistics (the fad chaser B index, connoisseur index, conservativeness index, and regular-fan index) of the noted user can be obtained for presentation to a user.

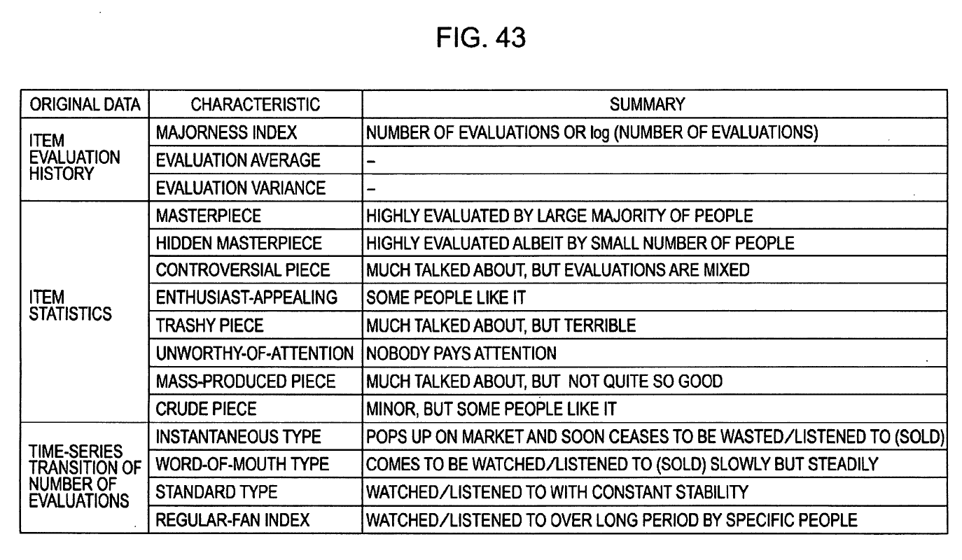

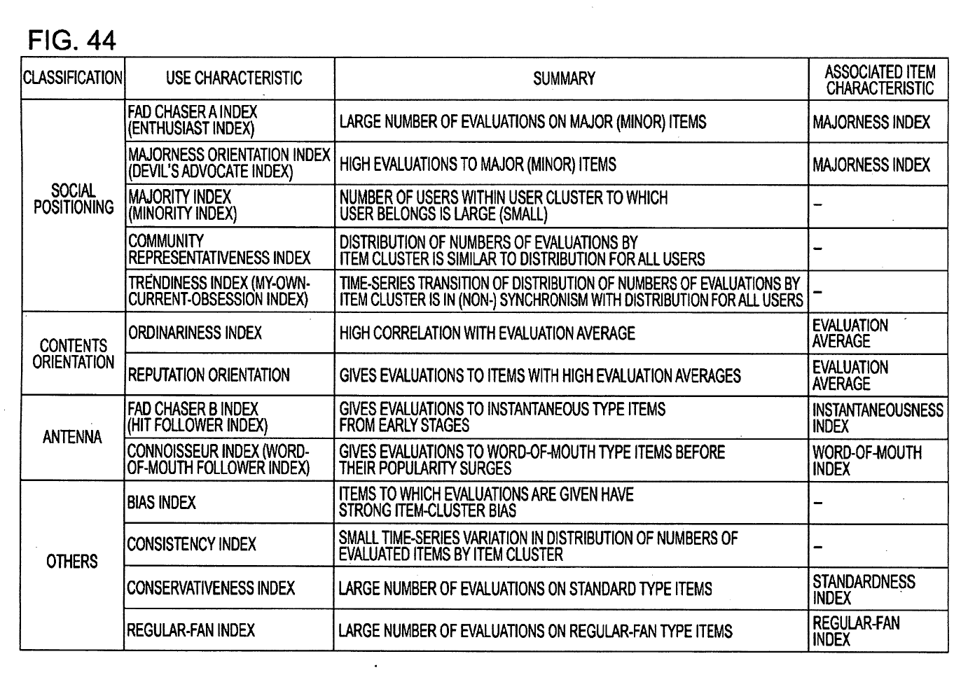

Now, referring to FIGS. 43 and 44, the user characteristics and the item characteristics described in the foregoing will be summarized.

FIG. 43 is a table summarizing item characteristics. Item characteristics are roughly classified into three groups, in accordance with the original data used for obtaining the item characteristics.

The first group represents the characteristics obtained on the basis of an item evaluation history, as described above with reference to FIG. 4 and the like. This group includes a majorness index, an evaluation average, and an evaluation variance.

The second group represents the characteristics obtained on the basis of item statistics including a majorness index, an evaluation average, and an evaluation variance, as described above with reference to FIGS. 4, 17, and the like. This group includes masterpiece, hidden masterpiece, controversial piece, enthusiast-appealing, trashy piece, unworthy-of-attention, mass-produced piece, and crude piece.

The third group represents the characteristics obtained on the basis of the time-series transition of the number of evaluations. This group includes an instantaneous type, a word-of-mouth type, a standard type, and a regular-fan type.

Since the summary of each individual characteristic has been described above, description thereof is omitted to avoid repetition.

FIG. 44 is a table summarizing user characteristics. User characteristics are roughly classified into four groups including characteristics related to the social positioning of a user, characteristics related to the tendency of user's orientations toward item contents, characteristics related to the user's antenna for catching new information, and other characteristics.

The group of characteristics related to the social positioning of a user include a fad chaser A index (or an enthusiast index as the opposite thereof), a majorness orientation index (or a devil's advocate index as the opposite thereof), a majority index (or a minority index as the opposite thereof), a community representativeness index, and a trendiness index (or a my-own-current-obsession index as the opposite thereof).

A user with a high fad chaser A index is such a user that the number of evaluations on major items with high majorness indexes tends to be large, that is, a user who tends to give a large number of evaluations to major items. On the other hand, a user with a high enthusiast index (a low fad chaser A index) is a user who tends to given a large number of evaluations to minor items with low majorness indexes, that is, a user who tends to given a large number of evaluations to minor items. Thus, the fad chaser A index and the enthusiast index are associated with the majorness index of an item.

A user with a high majorness orientation index is a user who tends to give high evaluations to major items. On the other hand, a user with a high devil's advocate index (a low majorness orientation index) is a user who tends to give high evaluations to minor items. Thus, the majorness orientation index and the devil's advocate index are associated with the majorness index of an item.

A user with a high majority index is a user who tends to belong to a user cluster with a large number of users. On the other hand, a user with a high minority index (a low majority index) is a user who tends to belong to a user cluster with a small number of users.

A user with a high community representativeness index is such a user that the distribution of the numbers of evaluations broken down by item cluster tends to be similar to the distribution for all users.

A user with a high trendiness index is such a user that the time-series transition of the distribution of the numbers of evaluations by item cluster tends to vary in synchronism with the distribution for all users. Conversely, a user with a high my-own-current-obsession index (a low trendiness index) is such a user that the time-series transition of the distribution of the numbers of evaluations by item cluster tends to vary in little synchronism with the distribution for all users.

The group of characteristics related to the tendency of user's orientations toward item contents include an ordinariness index and a reputation orientation.

A user with a high ordinariness index is such a user that the evaluation value on each individual item tends to have a high correlation with the evaluation average. Thus, the ordinariness index is associated with the evaluation average of an item.

A user with a high reputation orientation index is a user who tends to give evaluations to items with high evaluation averages. Thus, the evaluation orientation index is associated with the evaluation average of an item.

The group of characteristics related to the user's antenna for catching new information includes a fad chaser B index (or a hit follower index as the opposite thereof), and a connoisseur index (or a word-of-mouth index as the opposite thereof).

A user with a high fad chaser B index is a user who tends to give evaluations to instantaneous type items with high instantaneousness indexes from early stages. On the other hand, a user with a high hit follower index (or a low fad chaser B index) is a user who does not tend to give evaluations to instantaneous type items from early stages. Thus, the fad chaser B index and the hit follower index are associated with the instantaneousness index of an item.

A user with a high connoisseur index is a user who tends to give evaluations to word-of-mouth type items with high word-of-mouth indexes before the items attract attention and surge in popularity. On the other hand, a user with a high word-of-mouth follower index (a low connoisseur index) is a user who does not tend to give evaluations to word-of-mouth items with high word-of-mouth type indexes before the items attract attention and surge in popularity. Thus, the connoisseur index and the word-of-mouth follower index are associated with the word-of-mouth index of an item.

The group of other characteristics includes a bias index, a consistency index, and a regular-fan index.

A user with a high bias index is such a user that items evaluated by the user are strongly biased toward a specific item cluster.

A user with a high consistency index is such a user that the time-series variation in the distribution of the numbers of evaluated items by item cluster tends to be small, that is, such a user that the distribution of the numbers of evaluated items by item cluster does not vary much over time.

A user with a high conservativeness index is such a user that the number of evaluations on standard type items with high standardness indexes tends to be large, that is, a user who tends to give a large number of evaluations to standard type items. Thus, the conservativeness index is associated with the standardness index of an item.

A user with a high regular-fan index is such a user that the number of evaluations on regular-fan type items with high regular-fan indexes tends to be large, that is, a user who tends to give a large number of evaluations to regular-fan type items. Thus, the regular-fan index is associated with the regular-fan index of an item.

Next, referring to FIGS. 45 to 54, a description will be given of a process in which the information processing system 100 presents information related to an item to a user.

First, referring to the flowchart in FIG. 45, an information block personalization process will be described. An information block is a unit in which information is presented to a user. In the following description, a user to whom information is to be presented in this process will be referred to as noted user.

In step S401, the information presenting section 142 acquires presentation rules held by the presentation rules holding section 147. The presentation rules define branching conditions in the processing from step S402 onwards, and rules for displaying an information block. The presentation rules can be freely changed by a system provider.

In step S402, the information presenting section 142 determines whether or not a noted user has characteristics of Group 1. Specifically, the information presenting section 142 acquires information related to the noted user from the user information holding section 144. The information presenting section 142 determines that the noted user has characteristics of Group 1 if one of the following conditions is satisfied: the fad chaser A index of the noted user is equal to or higher than a predetermined threshold; the fad chaser B index of the noted user is equal to or higher than a predetermined threshold; the majorness orientation index of the noted user is equal to or higher than a predetermined threshold; the trendiness index of the noted user is equal to or higher than a predetermined threshold; and the bias index of the noted user is equal to or higher than a predetermined threshold. The process then proceeds to step S403.

In step S403, the information presenting section 142 presents an advertisement. Specifically, the information presenting section 142 generates information related to an advertisement for the noted user, and transmits the information to the display section 122. The display section 122 displays an advertisement on the basis of the acquired information. Thereafter, the process proceeds to step S404.

On the other hand, if it is determined in step S402 that the noted user does not have characteristics of Group 1, the processing of step S403 is skipped, and the process proceeds to step S404.

In step S404, the information presenting section 142 determines whether or not the noted user has characteristics of Group 2. Specifically, the information presenting section 142 determines that the noted user has characteristics of Group 2 if one of the following conditions is satisfied: the fad chaser A index of the noted user is equal to or higher than a predetermined threshold; the fad chaser B index of the noted user is equal to or higher than a predetermined threshold; the majorness orientation index of the noted user is equal to or higher than a predetermined threshold; the majority index of the noted user is equal to or higher than a predetermined threshold; the trendiness index of the noted user is equal to or higher than a predetermined threshold; the hit follower index of the noted user is equal to or higher than a predetermined threshold; and the word-of-mouth follower index of the noted user is equal to or higher than a predetermined threshold. The process then proceeds to step S405.

In step S405, the information presenting section 142 presents a ranking. Specifically, the information presenting section 142 generates information related to a ranking based on the numbers of evaluations on individual items, and transmits the information to the display section 122. The display section 122 displays a ranking of items on the basis of the acquired information. Thereafter, the process proceeds to step S406.

On the other hand, if it is determined in step S404 that the noted user does not have characteristics of Group 2, the processing of step S405 is skipped, and the process proceeds to step S406.

In step S406, the information presenting section 142 determines whether or not the noted user has characteristics of Group 3. Specifically, the information presenting section 142 determines that the noted user has characteristics of Group 3 if one of the following conditions is satisfied: the fad chaser A index of the noted user is less than a predetermined threshold; the trendiness index of the noted user is less than a predetermined threshold (the my-own-current-obsession index is equal to or higher than a predetermined threshold); and the bias index of the noted user is less than a predetermined threshold. The process then proceeds to step S407.

In step S407, the information presenting section 142 presents a recommendation list to the noted user. Specifically, the information presenting section 142 generates a list of recommended items for the noted user which are extracted from the item recommending process in FIG. 15 or 16 described above, for example, and transmits the list to the display section 122. On the basis of the acquired list, the display section 122 displays a recommendation list for the noted user. Thereafter, the process proceeds to step S408.

On the other hand, if it is determined in step S406 that the noted user does not have characteristics of Group 3, the processing of step S407 is skipped, and the process proceeds to step S408.

In step S408, the information presenting section 142 determines whether or not the noted user has characteristics of Group 4. Specifically, the information presenting section 142 determines that the noted user has characteristics of Group 4 if the reputation orientation index of the noted user is equal to or higher than a predetermined threshold. Then, the process proceeds to step S409.

In step S409, the information presenting section 142 presents item evaluation information. Specifically, when presenting the name and detailed information of a given item, the information presenting section 142 transmits the statistics of evaluations (for example, the evaluation average) given to the item to the display section 122, together with information related to the item. The display section 122 also displays the acquired evaluation statistics when presenting the acquired name and detailed information of an item. Thereafter, the process proceeds to step S410.

On the other hand, if it is determined in step S408 that the noted user does not have characteristics of Group 4, the processing of step S409 is skipped, and the process proceeds to step S410.

In step S410, the information presenting section 142 determines whether or not the noted user has characteristics of Group 5. Specifically, the information presenting section 142 determines that the noted user has characteristics of Group 5 if the connoisseur index of the noted user is equal to or higher than a predetermined threshold. Then, the process proceeds to step S411.

In step S411, the information presenting section 142 presents a new comer. Specifically, the information presenting section 142 generates information related to an item for which no definite evaluation has yet been established, and transmits the information to the display section 122. The display section 122 displays the acquired information as information related to a new comer. For example, in the case of a music distribution service, information oh a new artist for whom no definite evaluation has yet been established is displayed. Thereafter, the information block personalization process ends.

On the other hand, if it is determined in step S410 that the noted user does not have characteristics of Group 5, the processing of step S411 is skipped, and the information block personalization process ends.

In this way, information according to characteristics of the noted user represented by user statistics can be selected for presentation.

Other than selecting the information block to be displayed on the basis of the characteristics of a noted user as described above, for example, the priority of display, size, or the like of an information block may be changed as well.

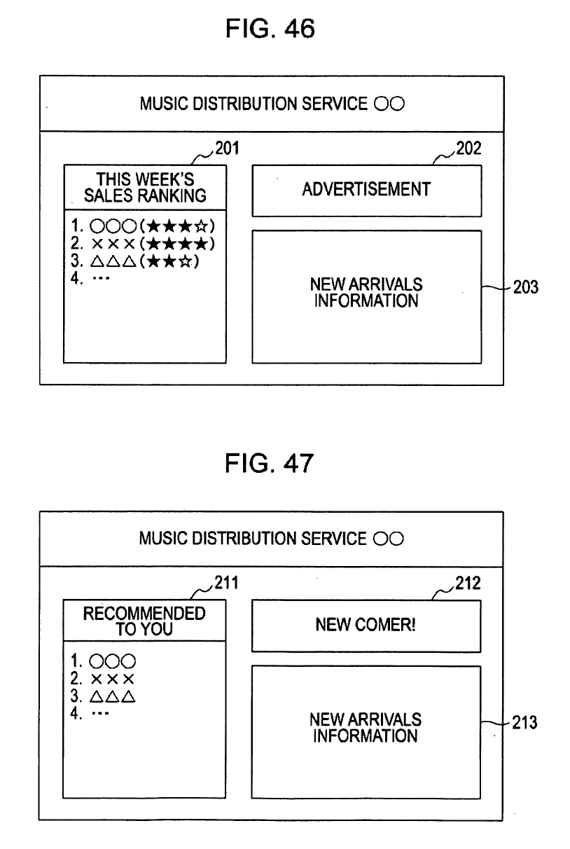

FIG. 46 shows an example of a screen that is displayed to a user with a high fad chaser A index and a high reputation orientation index in a music distribution service, on the basis of the above-mentioned information block personalization process. Through the process in FIG. 45, a user with a high fad chaser A index and a high reputation orientation index are determined to have characteristics of Group 1, Group 2, and Group 4. Therefore, on the screen in FIG. 46, a ranking window 201 displaying an item ranking, and an advertisement window 202 are displayed together with a new arrivals information window 203 for music content.

Also, FIG. 47 shows an example of a screen that is displayed to a user with a high my-own-current-obsession index and a high connoisseur index in a music distribution service, on the basis of the above-mentioned information block personalization process. Through the process in FIG. 45, a user with a high my-own-current-obsession index and a high connoisseur index are determined to have characteristics of Group 3 and Group 5. Therefore, on the screen in FIG. 47, a recommendation list window 212 displaying a list of recommended items, and a new comer window 212 displaying information related to a new comer who has not exploded in popularity yet are displayed together with a new arrivals information window 213 for music content.

Next, referring to the flowchart in FIG. 48, a filtering process will be described. In the following description, a user to whom information is to be presented in this process will be referred to as noted user.

In step S431, the recommended item extracting section 141 creates a base list. The recommended item extracting section 141 extracts items that match predetermined conditions by query search or the like, and creates a list of the extracted items, that is, a base list. For example, if the item is music content, a list of artists who play a predetermined genre (for example, pops, jazz, classic, or the like) of music is created as a base list.

In step S432, the recommended item extracting section 141 selects one item from the base list. Hereinafter, the thus selected item will be referred to as noted item.

In step S433, the recommended item extracting section 141 determines whether or not the item has characteristics that match the user. Specifically, the recommended item extracting section 141 acquires user information of the noted user from the user information holding section 143 via the information presenting section 142. The recommended item extracting section 141 extracts item characteristics associated with characteristics possessed by the noted user, in accordance with the table in FIG. 44.

Further, the recommended item extracting section 141 acquires item information of the noted item from the item information holding section 143 via the information presenting section 142. On the basis of the acquired item information, the recommended item extracting section 141 obtains the level of each individual item characteristic associated with each individual characteristic possessed by the noted user in the noted item. If the obtained level of the item characteristic is equal to or higher than a predetermined threshold, the recommended item extracting section 141 determines that the noted item has characteristics matching the noted user, and then the process proceeds to step S434. For example, in a case where the noted user has the characteristic of a fad chaser A (if the user's fad chaser index is equal to or higher than a predetermined threshold), if the majorness index of the noted item is equal to or higher than a predetermined threshold, then the above-mentioned condition is met.

In step S434, the recommended item extracting section 141 adds the noted item to a new list. Thereafter, the process proceeds to step S435.

On the other hand, if the obtained level of each individual item characteristic is less than the predetermined threshold in step S433, the recommended item extracting section 141 determines that the noted item is not an item having characteristics that match the noted user. Then, the processing of step S434 is skipped, and the process proceeds to step S435.

In step S435, the recommended item extracting section 141 determines whether or not the base list has been finished. If an item that has not been processed as a noted item still remains in the base list, the recommended item extracting section 141 determines that the base list has not been finished, and the process returns to step S432. Thereafter, the processing of steps S432 to S435 is repeated until it is determined that the base list has been finished, and items having characteristics matching the noted user are extracted from the base list and added to the new list.

On the other hand, if it is determined in step S435 that the base list has been finished, the process proceeds to step S436.

In step S436, the information presenting section 142 presents the new list to the user. Specifically, the recommended item extracting section 141 supplies the generated new list to the information presenting section 142. The information presenting section 142 acquires information related to items included in the new list from the item information holding section 143, and transmits the acquired information to the display section 122. On the basis of the acquired information, the display section 122 displays information related to items included in the new list. Thereafter, the filtering process ends.

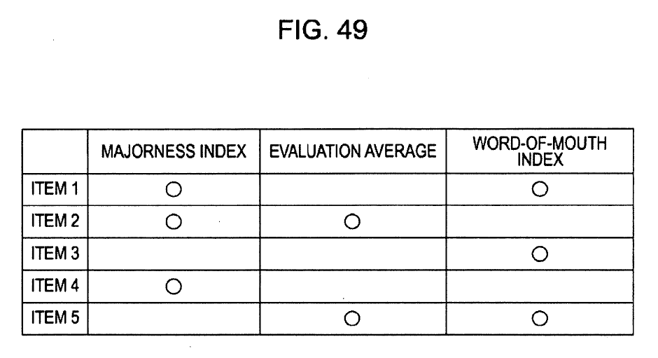

For example, a case is considered in which the fad chaser A index and reputation orientation index of the noted user are high, and the base list includes Items 1 to 5 having the characteristics as shown in FIG. 49. In the drawing, each column with a circle indicates that the level of the corresponding item characteristic is high. For example, Item 1 has a high majorness index, a low evaluation average, and a high word-of-mouth index.

In this case, from the table in FIG. 44, a majorness index is extracted as an item characteristic associated with the fad chaser A index, and an evaluation average is extracted as an item characteristic associated with the reputation orientation index. Therefore, Items 1, 2, 4, and 5 with high majorness indexes or high evaluation averages are extracted from the base list in FIG. 49, and presented to the noted user as the new list.

In this way, items having characteristics that are represented by item statistics and associated with characteristics of the noted user represented by user statistics can be extracted for presentation to the noted user.

If, as a result of performing such an item extracting process, there is not even a single item included in a new list, information related to all the items included in the base list may be presented.

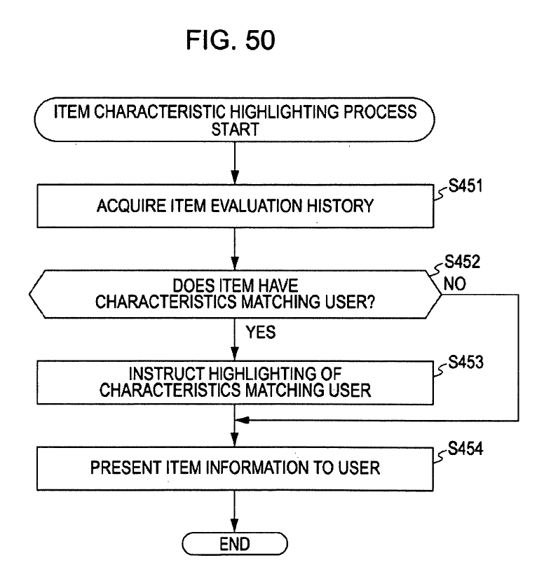

Next, referring to the flowchart in FIG. 50, an item characteristic highlighting process will be described. In the following description, a user to whom information is to be presented in this process will be referred to as noted user, and an item with respect to which information is presented will be referred to as noted item.

In step S451, the information presenting section 142 acquires item information. That is, the information presenting section 142 acquires the item information of a noted item from the item information holding section 143. The information presenting section 142 transmits the acquired item information to the display section 122.

In step S452, as in the processing by the recommended item extracting section 141 in step S433 of FIG. 48 described above, the information presenting section 142 determines whether or not the noted item has characteristics matching the noted user. If it is determined that the noted item has characteristics matching the noted user, the process proceeds to step S453.

In step S453, the information presenting section 142 instructs the display section 122 to highlight the characteristics matching the user. Specifically, the information presenting section 142 transmits information indicating the item characteristics matching the noted user, which is determined to be possessed by the noted item in step S452, to the display section 122, and instructs the display section 122 to highlight the item characteristics. Thereafter, the process proceeds to step S454.

If it is determined in step S452 that the noted item does not have characteristics matching the noted user, the processing of step S453 is skipped, and the process proceeds to step S454.

In step S454, the display section 122 presents item information to the user. That is, the display section 122 displays information related to the noted item.

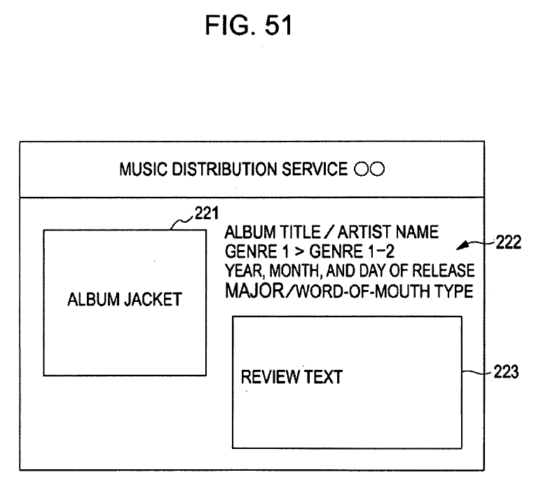

FIG. 51 shows an example of a screen that is displayed to a user with a high fad chaser A index and a high reputation orientation index in a music distribution service, on the basis of the above-mentioned item characteristic highlighting process. In an area 221, the album jacket of music content as a noted item is displayed. In an area 222, the album title, artist name, genre, year, month, and day of release, and item characteristics of the noted item are displayed. In an area 223, review text for the noted item is displayed. The display in the area 222 indicates that the noted item is a major type and word-of-mouth type item with high majorness and word-of-mouth indexes.

Now, from the table in FIG. 44, item characteristics associated with the fad chaser A index and the reputation orientation index are the majorness index and the evaluation average. Therefore, of the item characteristics displayed in the area 222, the words “major” are highlighted in thick, large letters. This makes it possible to direct more attention of the noted user to the noted item.

In this way, item characteristics represented by item statistics and associated with characteristics of the noted user represented by user statistics can be highlighted for presentation.

If the screen in FIG. 51 is displayed on a web site, highlighting can be realized by, for example, adding a class attribute to a tag including the item character “major”, and using a style sheet.

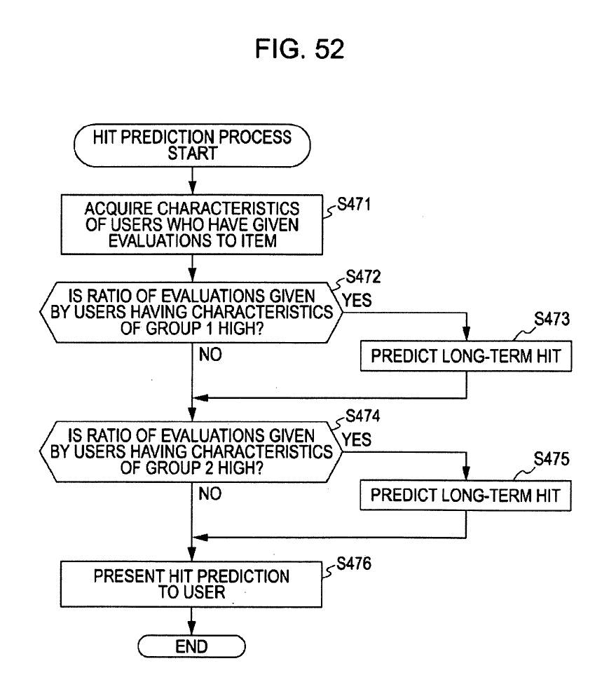

Next, referring to the flowchart in FIG. 52, a hit prediction process will be described. In the following description, an item with respect to which this process is performed will be referred to as noted item.

In step S471, the item statistics calculating section 133 acquires the characteristics of users who have given evaluations to an item. For example, the item statistics calculating section 133 acquires from the history holding section 132 an item evaluation history related to a noted item. On the basis of the acquired item evaluation history, the item statistics calculating section 133 extracts users who have given evaluations to the noted item. At this time, instead of extracting all the users who have given evaluations to the noted item, it is also possible, for example, to extract a predetermined number of users, or extract users who have given evaluations within a certain period of time after the release of the noted item. The item statistics calculating section 133 extracts the user information of the extracted users from the information holding section 144 via the information presenting section 142. The item statistics calculating section 133 tabulates the ratios of extracted users who possess individual user characteristics (hereinafter, referred to as possession rates).

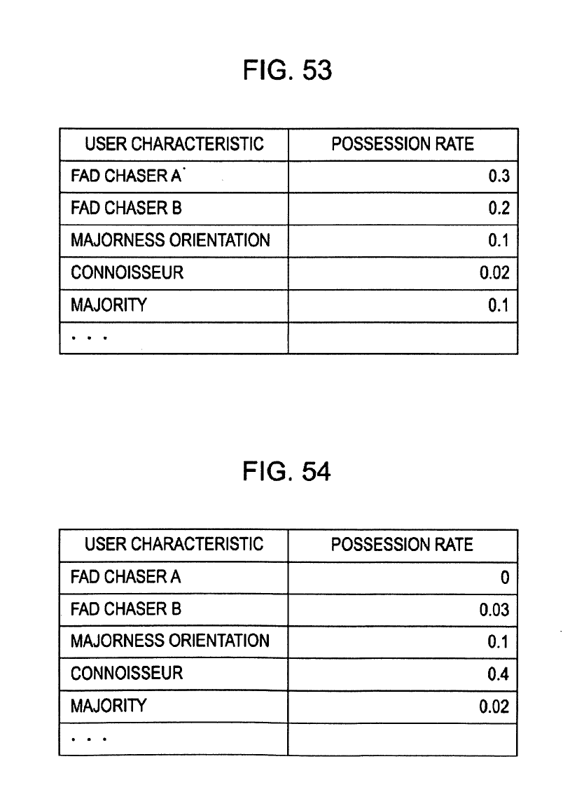

FIGS. 53 and 54 each show an example of possession rates of user characteristics by users who have evaluated Item 1 and Item 2. For example, FIG. 53 shows that, of users who have evaluated Item 1, the ratio of users having the fad chaser A characteristic whose fad chaser A indexes are equal to or higher than a predetermined threshold is 0.3, the ratio of users having the fad chaser B characteristic whose fad chaser B indexes are equal to or higher than a predetermined threshold is 0.2, the ratio of users having the majorness orientation characteristic whose majorness orientation indexes are equal to or higher than a predetermined threshold is 0.1, the ratio of users having the connoisseur characteristic whose connoisseur indexes are equal to or higher than a predetermined threshold is 0.02, and the ratio of users having the majority characteristic whose majority indexes are equal to or higher than a predetermined threshold is 0.1.

Also, FIG. 54 shows that, of users who have evaluated Item 2, the ratio of users having the fad chaser A characteristic whose fad chaser A indexes are equal to or higher than a predetermined threshold is 0, the ratio of users having the fad chaser B characteristic whose fad chaser B indexes are equal to or higher than a predetermined threshold is 0.03, the ratio of users having the majorness orientation characteristic whose majorness orientation indexes are equal to or higher than a predetermined threshold is 0.1, the ratio of users having the connoisseur characteristic whose connoisseur indexes are equal to or higher than a predetermined threshold is 0.4, and the ratio of users having the majority characteristic whose majority indexes are equal to or higher than a predetermined threshold is 0.02.

The item statistics calculating section 133 supplies information indicating the possession rates of individual user characteristics by users who have evaluated the noted item to the item type determining section 134.

In step S472, the item type determining section 134 determines whether or not the ratio of evaluations given by users having characteristics of Group 1 is high. Specifically, the item type determining section 134 obtains the sum of the possession rates of the fad chaser A, fad chaser B, and majorness orientation characteristics by users who have evaluated the noted item. If the obtained sum of the possession rates exceeds a predetermined threshold, the item type determining section 134 determines that the ratio of evaluations given by users having characteristics of Group 1 is high. Then, the process proceeds to step S473.

For example, from FIGS. 53 and 54, the sum of the possession rates of the fad chaser A, fad chaser B, and majorness orientation characteristics by users who have evaluated Item 1 is 0.6, and the sum of the possession rates of the fad chaser A, fad chaser B, and majorness orientation characteristics by users who have evaluated Item 2 is 0.13. For example, if the threshold is set as 0.4, it is determined that the ratio of evaluations given to Item 1 by users having characteristics of Group 1 is high, and it is determined that the ratio of evaluations given to Item 2 by users having characteristics of Group 1 is not high.

In step S473, the item type determining section 134 predicts a short-time hit of the noted item. That is, the item type determining section 134 predicts that many evaluations will be given to the noted item in the near future. The item type determining section 134 supplies information indicating that a short-term hit of the noted item has been predicted, to the information presenting section 142. The information presenting section 142 records the fact that a short-term hit has been predicted, into the information of the noted item held by the item information holding section 143. Thereafter, the process proceeds to step S474.

On the other hand, if the obtained sum of the possession rates is equal to or less than the predetermined threshold in step S472, the item type determining section 134 determines that the ratio of evaluations given by users having characteristics of Group 1 is not high, so the processing of step S473 is skipped, and the process proceeds to step S474.

In step S474, the item type determining section 134 determines whether or not the ratio of evaluations given by users having characteristics of Group 2 is high. Specifically, if the possession rate of the connoisseur characteristic by users who have evaluated the noted item exceeds a predetermined threshold, the item type determining section 134 determines that the ratio of evaluations given by users having characteristics of Group 2 is high. Then, the process proceeds to step S475.

For example, from FIGS. 53 and 54, the possession rate of the connoisseur characteristic by users who have evaluated Item 1 is 0.02, and the possession rate of the connoisseur characteristic by users who have evaluated Item 2 is 0.4. For example, if the threshold is set as 0.3, it is determined that the ratio of evaluations given to Item 1 by users having characteristics of Group 2 is not high, and it is determined that the ratio of evaluations given to Item 2 by users having characteristics of Group 2 is high.

In step S475, the item type determining section 134 predicts a long-time bit of the noted item. That is, the item type determining section 134 predicts that evaluations will be given to the noted item over a long period of time. The item type determining section 134 supplies information indicating that a long-term hit of the noted item has been predicted, to the information presenting section 142. The information presenting section 142 records the fact that a long-term hit has been predicted, into the information of the noted item held by the item information holding section 143. Thereafter, the process proceeds to step S476.

On the other hand, if the possession rate is equal to or less than the predetermined threshold in step S474, the item type determining section 134 determines that the ratio of evaluations given by users having characteristics of Group 2 is not high, so the processing of step S475 is skipped, and the process proceeds to step S476.

In step S476, the information presenting section 142 presents a hit prediction to the user. For example, when presenting information of a noted item to the user, the information presenting section 142 also transmits information indicating a hit prediction for that item to the display section 122. The display section 122 displays a hit prediction for the noted item together with information related to that item. For example, if the noted item is music content, a message like “The hottest up and coming!” is displayed when a short-time hit is predicted, and a message like “Our pickup artist” is displayed when a long-term hit is predicted.

In this way, whether an item will be a hit can be properly predicted on the basis of users' evaluations.

The series of processes described above can be executed either by hardware or by software. If the series of processes is to be executed by software, a program constituting the software is installed from a program recording medium into a computer built in dedicated hardware, or into, for example, a general purpose personal computer capable of executing various functions by installing various programs into the general purpose personal computer.

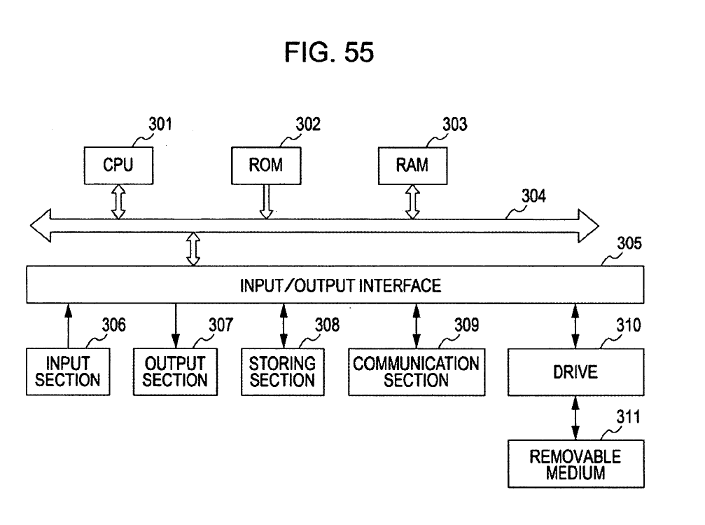

FIG. 55 is a block diagram showing an example of the hardware configuration of a computer that executes the series of processes described above by a program.

In the computer, a CPU (Central Processing Unit) 301, a ROM (Read Only Memory) 302, and a RAM (Random Access Memory) 303 are connected to each other by a bus 304.

The bus 304 is further connected with an input/output interface 305. The input/output interface 305 is connected with an input section 306 configured by a keyboard, a mouse, a microphone, or the like, an output section 307 configured by a display or a speaker, a storing section 308 configured by a hard disk, a non-volatile memory, or the like, a communication section 309 configured by a network interface or the like, and a drive 310 that drives a removable medium such as a magnetic disc, an optical disc, a magneto-optical disc, or a semiconductor memory.

In the computer configured as described above, the above-described series of processes is performed when the CPU 301 loads a program stored in the storing section 308 into the RAM 303 via the input/output interface 305 and the bus 304, and executes the program, for example.

The program to be executed by the computer (CPU 301) is provided by being recorded onto the removable medium 311 that is a package medium configured by a magnetic disc (including a flexible disc), an optical disc (such as a CD-ROM (Compact Disc-Read Only Memory) or a DVD (Digital Versatile Disc)), a magneto-optical disc, a semiconductor memory, or the like, or via a wired or wireless transmission medium such as the local area network, the Internet, or digital satellite broadcast.

The program can be installed into the storing section 308 via the input/output interface 305 by mounting the removable medium 311 on the drive 310. Also, the program can be received by the communication section 309 via a wired or wireless transmission medium and installed into the storage section 308. Otherwise, the program can be also pre-installed into the ROM 302 or the storing section 308.

The program to be executed by the computer may be a program in which processes are executed time sequentially in the order as they appear in this specification but may be a program in which processes are executed in parallel, or at necessary timing such as when the program is called.

The term system as used in this specification means an overall device configured by a plurality of devices, means, and the like.

Further, the embodiment of the present invention is not limited to the above-described embodiment, and can be modified in various ways without departing from the scope of the present invention.

What is claimed is:

1. An information processing device, comprising:
item evaluation acquiring means for acquiring evaluation values given to individual items by individual users;
user statistics calculating means for calculating user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user; and
presentation control means for controlling presentation of information related to an item to the noted user, on the basis of the user statistics.

2. The information processing device according to claim 1, further comprising:
item clustering means for clustering items by using a predetermined method,
wherein the user statistics calculating means calculates the user statistics on the basis of a cluster-specific distribution of the numbers of items evaluated by the noted user.

3. The information processing device according to claim 2, wherein:
the user statistics include a community representativeness index indicating a similarity index between the cluster-specific distribution of the numbers of items evaluated by the noted user, and the cluster-specific distribution of the numbers of evaluations by an entire community to which the noted user belongs.

4. The information processing device according to claim 3, wherein:
the user statistics further include a trendiness index based on a time-series average of the community representativeness index.

5. The information processing device according to claim 2, wherein:
the user statistics include a consistency index indicating a time-series stability index of the cluster-specific distribution of the numbers of items evaluated by the noted user.

6. The information processing device according to claim 2, wherein:
the user statistics include a bias index indicating a degree of bias in the cluster-specific distribution of the numbers of items evaluated by the noted user.

7. The information processing device according to any one of claims 1 to 6, wherein:
the presentation control means controls the presentation so as to select and present information matching a characteristic of the noted user represented by the user statistics.

8. The information processing device according to any one of claims 1 to 6, further comprising:
item statistics calculating means for calculating item statistics representing a tendency of evaluations given to individual items, on the basis of at least one of evaluation values and the numbers of evaluations given by individual users.

9. The information processing device according to claim 8, wherein:
the user statistics calculating means calculates the user statistics of the noted user on the basis of a characteristic possessed by a large number of items evaluated by the noted user, among item characteristics represented by the item statistics.

10. The information processing device according to claim 9, wherein:
the item statistics include at least one of an instantaneousness index based on a relative value of speed of decrease of the number of evaluations on each individual item with respect to an average speed of decrease of the number of evaluations from when individual items become available, a word-of-mouth index indicating a length of period during which the number of evaluations on each individual item increases and a degree of increase in the number of evaluations, and a standardness index indicating a time-series stability index of the number of evaluations on each individual item;
the user statistics include at least one of a fad chaser index based on a ratio of items evaluated within a predetermined period after the items become available and each having the instantaneousness index equal to or higher than a predetermined threshold, to items evaluated by the noted user, a connoisseur index based on a ratio of items evaluated within a predetermined period after the items become available and each having the word-of-mouth index equal to or higher than a predetermined threshold, to items evaluated by the noted user, and a conservativeness index based on a ratio of items each having the standardness index equal to or higher than a predetermined threshold, to items evaluated by the noted user.

11. The information processing device according to claim 9, wherein:
the item statistics include an item regular-fan index based on an average number of evaluations per one user on each individual item within a predetermined period; and
the user statistics include a user regular-fan index based on a ratio of items each having the item regular-fan index equal to or higher than a predetermined threshold, to items evaluated by the noted user.

12. The information processing device according to claim 8; wherein:
the item statistics include a majorness index based on the number of evaluations on each individual item, and an evaluation average that is an average of evaluation values of each individual item; and
the user statistics include a fad chaser index based on an average of the majorness index of each individual item evaluated by the noted user, a majorness orientation index based on a correlation between an evaluation value given to each individual item by the noted user and the majorness index of the item, an ordinariness index based on a correlation between an evaluation value given to each individual item by the noted user and the evaluation average of the item, and a reputation orientation index based on an average of the evaluation average of each individual item evaluated by the noted user.

13. The information processing device according to claim 8, wherein:
the presentation control means highlights and presents an item characteristic represented by the item statistics and associated with a characteristic of the noted user represented by the user statistics.

14. The information processing device according to claim 8, further comprising:
extracting means for extracting an item having a characteristic represented by the item statistics and associated with a characteristic of the noted user represented by the user statistics,
wherein the presentation control means controls the presentation so as to present the extracted item to the noted user.

15. The information processing device according to any one of claims 1 to 6, further comprising:
user similarity index calculating means for calculating a user similarity index indicating a similarity index between users, on the basis of the user statistics;
similar user extracting means for extracting a similar user similar to the noted user; and
extracting means for extracting an item to which a high evaluation value is given by the similar user, as an item to be recommended to the noted user,
wherein the presentation control means controls the presentation so as to present the extracted item as an item to be recommended to the noted user.

16. The information processing device according to any one of claims 1 to 6, further comprising:
user similarity index calculating means for calculating a user similarity index indicating a similarity index between users, on the basis of the user statistics;
predicted evaluation value calculating means for calculating a predicted evaluation value given to a noted item by the noted user, by using evaluation values given to the noted item by other users, and by assigning a large weight to an evaluation value given by a user whose value of the user similarity index to the noted user is high, and assigning a small weight to an evaluation value given by a user whose value of the user similarity index to the noted user is low; and
extracting means for extracting an item for which the predicted evaluation value is high, as an item to be recommended to the noted user,
wherein the presentation control means controls the presentation so as to present the extracted item as an item to be recommended to the noted user.

17. An information processing method for an information processing device, comprising the steps of:
acquiring evaluation values given to individual items by individual users;
calculating user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user; and
controlling presentation of information related to an item to the noted user, on the basis of the user statistics.

18. A program for causing a computer to execute a process including the steps of:
acquiring evaluation values given to individual items by individual users;
calculating user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user; and
controlling presentation of information related to an item to the noted user, on the basis of the user statistics.

19. An information processing device, comprising:
an item evaluation acquiring section configured to acquire evaluation values given to individual items by individual users;
a user statistics calculating section configured to calculate user statistics indicating an evaluation tendency of a noted user, by using at least one of the number of items evaluated by the noted user, evaluation values given by the noted user to individual items, the numbers of evaluations given by individual users to items evaluated by the noted user, and evaluation values given by individual users to items evaluated by the noted user; and
a presentation control section configured to control presentation of information related to an item to the noted user, on the basis of the user statistics.
